(19) United States
(12) Patent Application Publication
(10) Pub. No.: US 2026/0167769 A9
(43) Pub. Date: Jun. 18, 2026

(54) CHEMICALLY CIRCULAR POLYHYDROXYALKANOATES

(71) Applicant: COLORADO STATE UNIVERSITY RESEARCH FOUNDATION, Fort Collins, CO (US)

(72) Inventors: Eugene You-Xian CHEN, Fort Collins, CO (US); Li ZHOU, Fort Collins, CO (US)

(73) Assignee: COLORADO STATE UNIVERSITY RESEARCH FOUNDATION, Fort Collins, CO (US)

(21) Appl. No.: 18/863,667

(22) PCT Filed: May 9, 2023
(86) PCT No.: PCT/US2023/021512

§ 371 Date: Nov. 7, 2024

Related U.S. Application Data
(60) Provisional application No. 63/340,168, filed on May 10, 2022.
(60) Provisional application No. 63/434,550, filed on Dec. 22, 2022.

(51) Int. Cl. C08G 63/08; C08G 63/82; C08G 63/87; C08J 11/14; C08J 11/16

(52) U.S. Cl. CPC C08G 63/08; C08G 63/823; C08G 63/87; C08J 11/14; C08J 11/16; C08J 2367/04

(57) ABSTRACT

Polyhydroxyalkanoates (PHAs) have attracted increasing interest as sustainable plastics because of their biorenewability and biodegradability in the ambient environment. However, current semicrystalline PHAs face three long-standing challenges to broad commercial implementation and application: lack of melt processability, mechanical brittleness, and unrealized recyclability, the last of which is essential for achieving a circular plastics economy. Here we report a synthetic PHA platform that addresses the origin of thermal instability by eliminating α-hydrogens in the PHA repeat units and thus precluding facile cis-elimination during thermal degradation. This simple α,α-disubstitution in PHAs enhances the thermal stability so substantially that the PHAs become melt-processable. Synergistically, this structural modification also endows the PHAs with the mechanical toughness, intrinsic crystallinity, and closed-loop chemical recyclability.

### RELATED APPLICATIONS

This application claims priority under 35 U.S.C. § 119(e) to U.S. Provisional Patent Application Nos. 63/340,168 filed May 10, 2022, and 63/434,550 filed Dec. 22, 2022, which applications are incorporated herein by reference.

### GOVERNMENT SUPPORT

This invention was made with government support under grants DE-AC36-08G028308 and DE-SC0022290 awarded by the Department of Energy. The government has certain rights in the invention.

### BACKGROUND OF THE INVENTION

Polyhydroxyalkanoates (PHAs) are a class of polyester naturally accumulated biologically by living microorganisms or synthetically produced chemocatalytically from diverse feedstocks, especially biorenewable sources. They possess tunable thermomechanical properties and are biodegradable in the ambient environment, thus offering a more sustainable alternative to petroleum-derived and/or nondegradable plastics. Over the past 60-plus years, the ring-opening polymerization (ROP) of four-membered β-lactones, such as β-butyrolactone (β-BL), and their derivatives with different substituents at α and β positions, has been extensively studied to enable the chemical synthesis of PHAs, particularly poly(3-hydroxybutyrate) (P3HB), with atactic, iso-rich, syndio-rich, or syndiotactic stereomicrostructures (tacticities). More recently, purely isotactic P3HB that has a number-average molar mass (Mₙ) of 154 kDa, a narrow dispersity (Ð) of 1.01, and a high melting-transition temperature (Tₘ) of 171° to 175° C.; stereo-sequenced PHAs; polyolefin-like PHA copolymers; and alternating isotactic PHAs have also been realized through the ROP of eight-membered dialkyl diolides (8DL^{R}). In addition to its iso-tactic polypropylene (it-PP)-like high Tₘ, the highly crystalline it-P3HB exhibits excellent barrier properties that are superior to those of commodity plastics widely used in packaging, such as polyethylene (PE) and polyethylene terephthalate (PET). These attractive properties of PHAs, coupled with their biorenewability and biodegradability, offer a promising solution to combat the global plastics problem.

However, three long-standing challenges facing PHAs must be addressed before broad commercial implementation and applications can be realized: 1) thermal instability during melt-processing, 2) mechanical performance to overcome brittleness, and 3) closed-loop chemical recyclability. Accordingly, there is a need for developing PHAs that are thermally stable in melt and have superior mechanical performance, and are chemically recyclable to monomers.

### SUMMARY

This disclosure provides a class of new semi-crystalline polyesters with not only superior thermal and mechanical properties desired for broader use, but also high chemical recyclability to render their chemical circularity. The herein disclosed geminal-disubstituted polyesters at the position α to the ester carbonyl are rationally designed to exhibit the following combined and advanced properties as compared to the current polyesters: (a) higher melting temperatures for enhanced mechanical performance and broader application window; (b) higher degradation temperatures for better high-temperature performance and melt-processability; and (c) higher chemical recyclability for recovering the monomers in pure state and high yield and thus achieving chemical circularity. The invention also provides methods for making and recycling such polyesters.

Accordingly, this disclosure provides a polymer comprising Formula I:

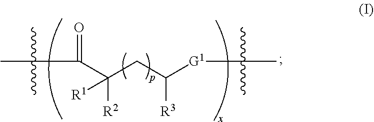

wherein
G¹ is O, S, or NR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
   R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl;
p is 0 to 5; and x is 10 or more.

This disclosure also provides a method for forming a polymer described above, comprising ring opening polymerization (ROP) of a monomer of Formula III, or step-growth polycondensation (SGP) of a monomer of Formula IV:

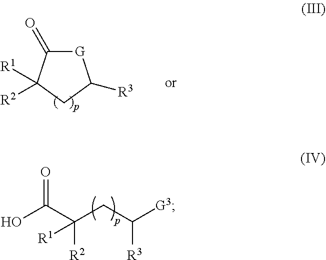

wherein
G¹ is O, S, or NR^{a} wherein R^{a} is H or —(C₁-C₁₂)alkyl;
G³ is OH, SH, or NHR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
   R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl; and
p is 0 to 5;
   wherein ROP comprises contacting the monomer of Formula III, a catalyst, and an initiator;
   wherein SGP comprises contacting the monomer of Formula IV and a catalyst;
   wherein the polymer is thereby formed.

Additionally, this disclosure provides a method for depolymerizing a polymer described above, comprising contacting the polymer and a base, wherein the polymer is depolymerized to its constituent monomer and conversion to the constituent monomer is about 20 wt. % or more.

The technology provides novel polymers or copolymers of Formula I and Formula II, intermediates for the synthesis of polymers or copolymers of Formula I and Formula II, as well as methods of preparing polymers or copolymers of Formula I and II. The technology also provides polymers or copolymers of Formula I and II that are useful as intermediates for the synthesis of other useful polymers or copolymers.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Shear viscosity (r*=1 s⁻¹) in melt (190° C.) of P3H(Me)₂B with medium to high molar mass (Mₙ=79-554 kDa), showing no decrease in viscosity over 30 min, indicating melt processability.

FIGS. 2A-B. (A) Overlays of ¹³C NMR spectra [(CF₃)₂CDOD] of P3H(Me)₂B derived from (Me)₂BL/^{t}Bu-P₄/BnOH=800:0.5:1: (S)-(Me)₂BL/(R)-(Me)₂BL>99:1 (top),=70:30 (middle), =50:50 (bottom). (B) Overlays of ¹H NMR spectra (23° C., CDCl₃) of the virgin (1) and recycled (2) lactone (Me)₂BL, virgin P3H(Me)₂B (3), and virgin (4) and recycled (5) HA monomer 3H(Me)₂BA.

FIGS. 3A-C. Intrinsic crystallinity and high thermal stability. (A) Second heating DSC scan (10° C./min) curves for isotactic (top), iso-rich (middle), and atactic (bottom) P3H(Me)₂B materials. (B) WAXS profiles of it-P3H(Me)₂B (top) and at-P3H(Me)₂B (bottom), showing nearly identical diffraction patterns and a similar degree of crystallinity. (C) TGA curves for it-P3H(Me)₂B (left) and at-P3H (Me)₂B (right), showing a 13° C. higher T_{d} for at-P3H(Me)₂B.

FIGS. 4A-C. Mechanical and rheological properties. (A) Representative stress-strain curves of P3H(Me)₂B (Mₙ=554 kDa, 1), P3H(Et)₂B (Mₙ=468 kDa, 4), and P3H(Me/Et)₂B (Mₙ=293 kDa, 3), overlaid with it-PP (Mₙ=97.0 kDa, 2) and HDPE (melt-flow index=7.6, 5). Strain rate=5 mm/min, ambient condition. (B) A representative stress-strain curve of P3H(Me)₂B (Mₙ=365 kDa) prepared from a large (>100 g)-scale run. Strain rate=5 mm/min, ambient condition. Inset: Photos of the simple reaction setup and the isolated pure P3H(Me)₂B (115 g) from the ROP of (Me)₂BL under industrially relevant conditions [70° C., solvent free, low catalyst loading (55 ppm) and high monomer conversion (96%)]. (C) Overlays of shear viscosity in melt (sheer rate r*=1 s⁻¹): P3H(Me)₂B (Mₙ=79 kDa, 190° C.; 200° C.; 210° C.; 220° C.) in reference to it-P3HB (Mₙ=111 kDa, 180° C.).

FIGS. 5A-F. (A) Overlays of ¹H NMR spectra (23° C., CDCl₃) of the started and recycled lactone (Me)₂PL, started P3H(Me)₂P, and started and recycled HA 3H(Me)₂PA. (B) DSC thermograms for P3H(Me)₂P (Mₙ=162 kDa) obtained by ROP and P3H(Me)₂P (Mₙ=11.7 kDa) by SGP. Exothermic (up) and endothermic (down) peaks for crystallization and melting temperatures, respectively. (C) DSC curves of 1^{st} cooling and 2^{nd} heating scans of P3H(ⁿPr)₂P prepared with [(ⁿPr)₂PL]/[^{t}Bu-P₄]/[BnOH]=1600/1/1. Scan rate: 10° C./min. (D) WAXS profiles of P3H(Me)₂P materials prepared by ROP and SGP, showing essentially identical diffraction patterns and peak intensities. Representative stress-strain curves of (E) P3H(Me/Et)₂P (Mₙ=79 kDa), (F) P3H(Me)₂P (Mₙ=162 kDa) and P3H(Et)₂P (Mₙ=80 kDa).

### DETAILED DESCRIPTION

The invention provides technologically important polyesters with not only physical and chemical properties required for practical use, but also high chemical recyclability to render their chemical circularity. These redesigned, geminal-disubstituted polyesters at the position α to the ester carbonyl (also the 2-position) exhibit the following combined and advanced properties relative to the current polyesters: (a) higher Tₘ values thus enhanced mechanical performance and broader application window; (b) higher T_{d} values (due to the absence of a hydrogens) thus better high-temperature performance and melt-processability; and (c) higher chemical recyclability to enable clean monomer recovery thus achieving chemical circularity. The invention also provides methods for making and recycling such polyesters. Specially, the invention provides a class of high-performance, circular polyesters shown in Chart 1.

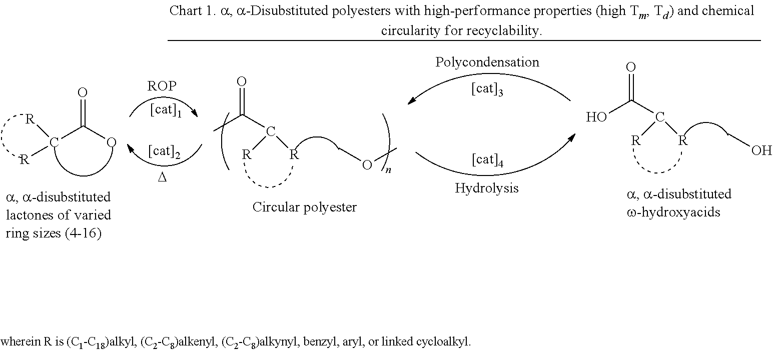

The α,α-disubstituted polyesters are produced by either the ROP of the corresponding lactones of vaned ring sizes from small 4-membered to large 16-membered macrolactones, or by polycondensation of the corresponding α,α-disubstituted o-hydroxyacids. The polyesters are semi-crystalline materials with Tₘ≥110° C., exhibit thermal stability with T_{d}≥250° C., and possess high chemical recyclability with pure monomer recovery ≥75%. To optimize performance properties, copolymers of different polyesters can also be formed via copolymerization of two or more different disubstituted lactones, or between one disubstituted and the other unsubstituted lactones.

Additional information and data supporting the invention can be found in the following publication by the inventors: Science 380, 64-69 (2023) and its Supplementary Materials, which are incorporated herein by reference in its entirety.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, or in a reaction mixture.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983); for heterocyclic synthesis see Hermanson, Greg T., Bioconjugate Techniques, Third Edition, Academic Press, 2013.

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. Mn, John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below or otherwise described herein. The alkyl can also be optionally partially or fully unsaturated. As such, the recitation of an alkyl group can include an alkenyl group or an alkynyl group.

The alkyl can be a monovalent hydrocarbon radical, as described and exemplified above, or it can be a divalent hydrocarbon radical (i.e., an alkylene).

An alkylene is an alkyl group having two free valences at a carbon atom or two different carbon atoms of a carbon chain. Similarly, alkenylene and alkynylene are respectively an alkene and an alkyne having two free valences at two different carbon atoms, or an alkenylene can have the two free valences on the same carbon.

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “heteroatom” refers to any atom in the periodic table that is not carbon or hydrogen. Typically, a heteroatom is O, S, N, P. The heteroatom may also be a halogen, metal or metalloid.

The term “heterocycloalkyl” or “heterocyclyl” refers to a saturated or partially saturated monocyclic, bicyclic, or polycyclic ring containing at least one heteroatom selected from nitrogen, sulfur, oxygen, preferably from 1 to 3 heteroatoms in at least one ring. Each ring is preferably from 3- to 10-membered, more preferably 4 to 7 membered. Examples of suitable heterocycloalkyl substituents include pyrrolidyl, tetrahydrofuryl, tetrahydrothiofuranyl, piperidyl, piperazyl, tetrahydropyranyl, morpholino, 1,3-diazapane, 1,4-diazapane, 1,4-oxazepane, and 1,4-oxathiapane. The group may be a terminal group or a bridging group.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted with a substituent described below. For example, a phenyl moiety or group may be substituted with one or more substituents Rx where Rx is at the ortho-, meta-, orpara-position, and X is an integer variable of 1 to 5.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms, wherein the ring skeleton comprises a 5-membered ring, a 6-membered ring, two 5-membered rings, two 6-membered rings, or a 5-membered ring fused to a 6-membered ring. Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, haloalkyl, hydroxyalkyl, aryl, heteroaryl, heterocyclyl, cycloalkyl, alkanoyl, alkoxycarbonyl, amino, alkylamino, dialkylamino, carboxyalkyl, alkylthio, alkylsulfinyl, and alkylsulfonyl. Substituents of the indicated groups can be those recited in a specific list of substituents described herein, or as one of skill in the art would recognize, can be one or more substituents selected from alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano. Suitable substituents of indicated groups can be bonded to a substituted carbon atom include F, Cl, Br, I, OR′, OC(O)N(R′)₂, CN, CF₃, OCF₃, R′, O, S, C(O), S(O), methylenedioxy, ethylenedioxy, N(R′)₂, SR′, SOR′, SO₂R′, SO₂N(R′)₂, SO₃R′, C(O)R′, C(O)C(O)R′, C(O)CH₂C(O)R′, C(S)R′, C(O)OR′, OC(O)R′, C(O)N(R′)₂, OC(O)N(R′)₂, C(S)N(R′)₂, (CH₂)₀₋₂NHC(O)R′, N(R′)N(R′)C(O)R′, N(R′)N(R′)C(O)OR′, N(R′)N(R′)CON(R′)₂, N(R′)SO₂R′, N(R′)SO₂N(R′)₂, N(R′)C(O)OR′, N(R′)C(O)R′, N(R′)C(S)R′, N(R′)C(O)N(R′)₂, N(R′)C(S)N(R′)₂, N(COR′)COR′, N(OR′)R′, C(═NH)N(R′)₂, C(O)N(OR′)R′, or C(═NOR′)R′ wherein R′ can be hydrogen or a carbon-based moiety (e.g., (C₁-C₆)alkyl), and wherein the carbon-based moiety can itself be further substituted. When a substituent is monovalent, such as, for example, F or Cl, it is bonded to the atom it is substituting by a single bond. When a substituent is divalent, such as O, it is bonded to the atom it is substituting by a double bond; for example, a carbon atom substituted with O forms a carbonyl group, C═O.

Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The compounds of the invention may contain asymmetric or chiral centers, and therefore exist in different stereoisomeric forms. It is intended that all stereoisomeric forms of the compounds of the invention, including but not limited to, diastereomers, enantiomers and atropisomers, as well as mixtures thereof, such as racemic mixtures, which form part of the present invention. Many organic compounds exist in optically active forms, i.e., they have the ability to rotate the plane of plane-polarized light. In describing an optically active compound, the prefixes D and L, or R and S. are used to denote the absolute configuration of the molecule about its chiral center(s). The prefixes d and 1 or (+) and (−) are employed to designate the sign of rotation of plane-polarized light by the compound, with (−) or 1 meaning that the compound is levorotatory. A compound prefixed with (+) or d is dextrorotatory. For a given chemical structure, these stereoisomers are identical except that they are mirror images of one another. A specific stereoisomer may also be referred to as an enantiomer, and a mixture of such isomers is often called an enantiomeric mixture. A 50:50 mixture of enantiomers is referred to as a racemic mixture or a racemate (defined below), which may occur where there has been no stereoselection or stereospecificity in a chemical reaction or process.

The terms “racemic mixture” and “racemate” refer to an equimolar mixture of two enantiomeric species, devoid of optical activity.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

A non-polar solvent is a liquid or solvent that has a low or non-existing dipole moment and is missing any partial positive or negative charges. Generally, it has small differences in electronegativity between atoms in the solvent molecule and has a low dielectric constant. A non-polar solvents cannot effectively dissolve a polar compound. Examples of a non-polar solvent includes alkanes, toluene, chloroform and diethyl ether.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

The term “molecular weight” for the copolymers disclosed herein refers to the average number molecular weight (Mₙ). The corresponding weight average molecular weight (M_{w}) can be determined from other disclosed parameters by methods (e.g., by calculation) known to the skilled artisan.

The copolymers disclosed herein can comprise random or block copolymers. In various embodiments, the ends of the polymer or copolymer (i.e., the initiator end or terminal end), is a low molecular weight moiety (e.g. under 500 Da), such as, H, OH, OOH, CH₂OH, CN, NH₂, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer.

### Embodiments of the Technology

1. A polymer comprising Formula I:

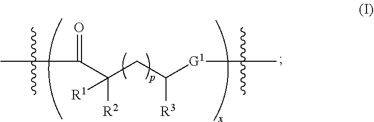

wherein
   G¹ is O, S, or NR^{a} wherein R^{a} is H or —(C₁-C₁₂)alkyl;
   R¹ and R² are each independently —(C₁-C₁₂)alkyl, —(C₂-C₁₂)alkenyl, —(C₂-C₁₂)alkynyl, aryl or heteroaryl; or
      R¹ and R² taken together with the carbon atom to which they are attached form a (C₃-C₁₆)cycloalkyl;
   R³ is H, —(C₁-C₁₂)alkyl, —(C₂-C₁₂)alkenyl, —(C₂-C₁₂)alkynyl, aryl or heteroaryl; p is 0, 1, 2, 3, 4, or 5; and x is 10 or more.
2. The polymer of embodiment 1 wherein R¹ and R² are each individually methyl, ethyl, propyl, butyl, pentyl, hexyl, or heptyl, and R³ is H, methyl, ethyl, propyl, or butyl, pentyl, hexyl, or heptyl. In some embodiments, propyl is n-propyl or isopropyl. In some embodiments, butyl is n-butyl, iso-butyl, or tert-butyl. In some embodiments, pentyl is n-pentyl or isopentyl.
3. The polymer of embodiment 1 or 2 wherein p is 0, 1, or 2.

In various embodiments, the repeating units represented by x (x-units) are at least 60% isotactic or at least 60% syndiotactic. In some embodiments, the % isotactic repeating x-units are about 10%, about 20%, about 30%, about 40%, about 50%, about 60%, about 70%, about 80%, about 90%, about 95%, about 99%. In some embodiments, the % syndiotactic repeating x-units are about 10%, about 20%, about 30%, about 40%, about 50%, about 60%, about 70%, about 80%, about 90%, about 95%, about 99%.
4. The polymer of any one of embodiments 1-3 wherein x is about 20 to about 500,000. In some embodiments, x is 1-10, 10-100, about 100, about 1,000, about 10,000, about 50,000, about 100,000, about 200,000, about 300,000, about 400,000, about 500,000, about 600,000, about 700,000, about 800,000, about 900,000, or about 1,000,000.
5. A polymer of any one of embodiments 1-5 wherein the polymer is a copolymer comprising Formula II:

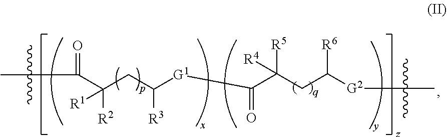

wherein
   G¹ and G² are each independently O, S, or NR wherein R is H or —(C₁-C₁₂)alkyl;
   R⁴ and R are each independently —(C₁-C₁₂)alkyl, —(C₂-C₁₂)alkenyl, —(C₂-C₁₂)alkynyl, aryl or heteroaryl; or
      R⁴ and R taken together with the carbon atom to which they are attached form a (C₃-C₁₆)cycloalkyl;
   R⁶ is H, —(C₁-C₁₂)alkyl, —(C₂-C₁₂)alkenyl, —(C₂-C₁₂)alkynyl, aryl or heteroaryl;
   q is 0, 1, 2, 3, 4, or 5;
   y is 10 or more; and
   z is 1 or more;
wherein the structure of the repeating units represented by x and y of Formula II are different (e.g., not the same). For example, at least one variable of Formula II, selected from G², R⁴, R⁵, R⁶, and q is different from a corresponding variable of Formula II (or Formula I) selected from G¹, R¹, R², R, and p, such that the structure of a monomer represented by y of Formula II is different from the structure of a monomer represented by x of Formula II (or Formula I).
6. The copolymer of embodiment 5 wherein R⁴ and R⁵ are methyl, ethyl, propyl, or butyl, pentyl, hexyl, or heptyl, and R⁶ is hydrogen, methyl, ethyl, propyl, butyl, pentyl, hexyl, or heptyl. In some embodiments, propyl is n-propyl or isopropyl. In some embodiments, butyl is n-butyl, iso-butyl, or tert-butyl. In some embodiments, pentyl is n-pentyl or isopentyl.

In various embodiments, the repeating units represented by y (y-units) are at least 60% isotactic or at least 60% syndiotactic. In some embodiments, the % isotactic repeating y-units are about 10%, about 20%, about 30%, about 40%, about 50%, about 60%, about 70%, about 80%, about 90%, about 95%, about 99%. In some embodiments, the % syndiotactic repeating y-units are about 10%, about 20%, about 30%, about 40%, about 50%, about 60%, about 70%, about 80%, about 90%, about 95%, about 99%.
7. The copolymer of embodiment 5 or 6 wherein y is about 20 to about 500,000 and z is about 10 to about 100,000. In some embodiments, y is 1-10, 10-100, about 100, about 1,000, about 10,000, about 50,000, about 100,000, about 200,000, about 300,000, about 400,000, about 500,000, about 600,000, about 700,000, about 800,000, about 900,000, or about 1,000,000. In some embodiments, z is about 1 to about 500,000. In some embodiments, z is about 10, about 100, about 1,000, about 10,000, about 50,000, about 100,000, about 200,000, about 300,000, about 400,000, or about 500,000.
8. A method for forming a polymer of any one of embodiments 1-7, comprising ring opening polymerization (ROP) of a monomer of Formula III:

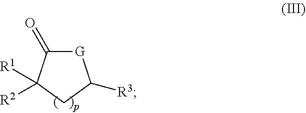

wherein
   G¹ is O, S, or NR^{a} wherein R^{a} is H or —(C₁-C₁₂)alkyl;
   R¹ and R² are each independently —(C₁-C₁₂)alkyl, —(C₂-C₁₂)alkenyl, —(C₂-C₁₂)alkynyl, aryl or heteroaryl; or
      R¹ and R² taken together with the carbon atom to which they are attached form a (C₃-C₁₆)cycloalkyl;
   R³ is H, —(C₁-C₁₂)alkyl, —(C₂-C₁₂)alkenyl, —(C₂-C₁₂)alkynyl, aryl or heteroaryl; and
   p is 0, 1, 2, 3, 4, or 5;
wherein ROP comprises contacting the monomer of Formula III with a catalyst and an initiator, wherein the polymer is thereby formed.
9. The method of embodiment 8 wherein the catalyst is {1-tert-butyl-4,4,4-tris(dimethylamino)-2,2-bis[tris(dimethylamino)phosphoranyliden-amino]2λ⁵,4λ⁵-catenadi(phosphazene)}(^{t}Bu-P₄), 1,5,7-triazabicyclo[4.4.0]dec-5-ene (TBD), 1,8-diazabicyclo[5.4.0]undec-7-ene (DBU), titanium tert-butoxide, or a lanthanide.

In some embodiments, the initiator is an alcohol, an aliphatic alcohol, an aryl alcohol, a diol, a polyol, benzyl alcohol (BnOH), methanol, ethanol, propanol, isopropanol, butanol, an amine, or a thiol.
10. A method for forming a polymer of any one of embodiments 1-7, comprising step-growth polycondensation (SGP) of a monomer of Formula IV:

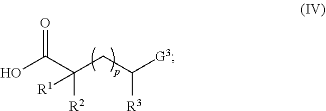

wherein
   G³ is OH, SH, or NHR^{a} wherein R^{a} is H or —(C₁-C₁₂)alkyl;
   R¹ and R² are each independently —(C₁-C₁₂)alkyl, —(C₂-C₁₂)alkenyl, —(C₂-C₁₂)alkynyl, aryl or heteroaryl; or
      R¹ and R² taken together with the carbon atom to which they are attached form a (C₃-C₁₆)cycloalkyl;
   R³ is H, —(C₁-C₁₂)alkyl, —(C₂-C₁₂)alkenyl, —(C₂-C₁₂)alkynyl, aryl or heteroaryl; and
   p is 0 to 5;
wherein SGP comprises contacting the monomer of Formula IV and a catalyst;
wherein the polymer is thereby formed.
11. The method of embodiment 10 wherein the catalyst is a Lewis acid. In some embodiments, the Lewis acid is BF₃·OEt₂, B(C₆F₅)₃, or Ti(OⁿBu)₄.

In various embodiments, chemical reaction described herein reactions comprises cooling or warming (heating) the reaction. In some embodiments the reaction is hydrolysis, lactonization, ROP, or SGP to facilitate a said reaction.

In some embodiments, warming or heating is performed at a temperature below or above room temperature, e.g., about −80° C., about −70° C., about −60° C., about −50° C., about −40° C., about −30° C., about −20° C., about −10° C., about 0° C., about 20° C., about 30° C., about 40° C., about 50° C., about 60° C., about 70° C., about 80° C., about 90° C., about 100° C., about 125° C., about 150° C., about 175° C., about 200° C., about 210° C., or about 250° C.
12. The method of any one of embodiments 8-11 wherein the monomer of Formula III or Formula IV is optically active. In some embodiments, the carbon attached to R³ in Formula III of Formula IV has an (S)-configuration or an (R)-configuration.
13. A method for depolymerizing a polymer or copolymer of any one of embodiments 1-9, comprising contacting the polymer with a base, wherein the polymer is depolymerized to its constituent monomer. In some embodiments, conversion to the constituent monomer is about 20 wt. % or more based on the initial weight of the polymer or copolymer. In some embodiments, the wt. % conversion is about 30%, about 40%, about 50%, about 60%, about 70%, about 80%, about 90%, about 95%, or about 99%.

In some embodiments, the base is an aqueous base. In some embodiments, the base is an alkali base. In some embodiments, the base is sodium hydroxide or lithium hydroxide.

In some embodiments, the base is an inorganic base. In some embodiments, inorganic base is an alkoxide like sodium hydroxide, an oxide such as lithium oxide, a hydride such as potassium hydride, a carbonate such as potassium carbonate. In some embodiments, the inorganic base can be replaced with a salt such as lithium chloride.

In some embodiments, depolymerizing comprises warming or heating to facilitate a depolymerization reaction. In some embodiments, warming or heating is performed at a temperature above room temperature, about 50° C., about 100° C., about 150° C., about 200° C., about 210° C., about 220° C., about 230° C., about 240° C., about 250° C., about 260° C., about 280° C., or about 300° C.
14. The method of embodiment 13 wherein the constituent monomer is represented by Formula III:

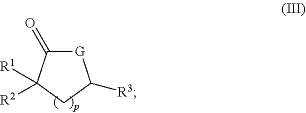

wherein
   G¹ is O, S, or NR^{a} wherein R^{a} is H or —(C₁-C₁₂)alkyl;
   R¹ and R² are each independently —(C₁-C₁₂)alkyl, —(C₂-C₁₂)alkenyl, —(C₂-C₁₂)alkynyl, aryl or heteroaryl; or
      R¹ and R² taken together with the carbon atom to which they are attached form a (C₃-C₁₆)cycloalkyl;
   R³ is H, —(C₁-C₁₂)alkyl, —(C₂-C₁₂)alkenyl, —(C₂-C₁₂)alkynyl, aryl or heteroaryl; and
   p is 0, 1, 2, 3, 4, or 5.
15. The method of embodiment 13 wherein the constituent monomer is represented by Formula IV:

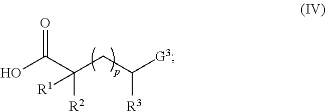

wherein
   G³ is OH, SH, or NHR^{a} wherein R^{a} is H or —(C₁-C₁₂)alkyl;
   R¹ and R² are each independently —(C₁-C₁₂)alkyl, —(C₂-C₁₂)alkenyl, —(C₂-C₁₂)alkynyl, aryl or heteroaryl; or
      R¹ and R² taken together with the carbon atom to which they are attached form a (C₃-C₁₆)cycloalkyl;
   R³ is H, —(C₁-C₁₂)alkyl, —(C₂-C₁₂)alkenyl, —(C₂-C₁₂)alkynyl, aryl or heteroaryl; and
p is 0, 1, 2, 3, 4, or 5.

Embodiments of Polymerization Processes: The ROP is typically carried out under solvent-free conditions (i.e., bulk polymerization), or in solution (e.g., in toluene, methylene chloride), at room temperature in the presence of catalyst. Suitable ROP catalysts can also be grouped into four classes: lanthanide (also referred to as rare-earth metal), transition-metal, main-group, and organic catalysts. They can be used alone but can also be employed in combination with a protic initiator such as alcohol.

Lanthanide (Ln) catalysts include f-block metal homoleptic and heteroleptic amides, alkoxide and alkyl complexes such as Ln(NR₂)₃, Ln(OR)₃, LnR₃, Ln(NR₂)ₓ(OR)₃₋ₓ(x=1, 2), or discrete LLn-X complexes [L=dianionic ligand, bridged or unbridged, polydentate organic ligands such as a tetradentate amino-alkoxy-bis(phenoxy); X=OR, NR₂, SR, R, where R is alkyl, aryl, substituted alkyl, or substituted aryl]. Transition-metal catalysts include d-block metal discrete molecular complexes carrying at least one labile ligand, LₙM-X (X=OR, NR₂, SR, R), where R is alkyl, aryl, substituted alkyl, or substituted aryl, which complexes can either directly initiate the polymerization or react with an initiator to generate an active species. The metal center is typically protected by one or more bulky mono-dentate or polydentate organic ligands such as a tetradentate amino-alkoxy-bis(phenoxy) ligand. Main-group catalysts include sand p-block metal (groups 1, 2, 12, and 13) metal homoleptic and heteroleptic complexes such as RLi, MgR₂, LM-X (Mₙ=Mg, Zn, X=R, OR, SR, NR₂), Al(OR)₃, and L₂AlOR, where R is alkyl, aryl, substituted alkyl, or substituted aryl.

Organic catalysts are those strong organic bases or nucleophiles, such as 1,5,7-triazabicyclo[4.4.0]dec-5-ene (TBD), that can either directly initiate the polymerization or activate a protic initiator to promote the polymerization. Basic catalysts can be grouped into two general classes: strong organic bases and inorganic bases. They can be used alone but are often used in combination with a protic initiator. Organic catalysts include strong organic bases, especially polyaminophosphazene superbases such as TBD, 1-tert-butyl-4,4,4-tris(dimethylamino)-2,2-bis[tris(dimethylamino)-phosphoranylidenamino]-2λ⁵,4λ⁵-catenadi(phosphazene) (^{t}Bu-P₄); guanidines such as, proazaphosphatranes (cyclic azaphosphines), and cyclopropenimine superbases, including the following catalysts. Anionic versions of organic catalysts/initiators such as urea or thiourea anions can also be used.

Inorganic bases include strong bases of alkaline and alkaline earth compounds such as ROM (R=Me, Et, ⁱPr, ⁿBu, ^{t}Bu; Mn=K, Na, Li), (RO)₂M (R=Me, Et, ⁱPr, ⁿBu, ^{t}Bu; Mₙ=Mg or Ca), MH (Mₙ=K, Na, Li), MOH (M=K, Na, Li), and R₂NM (R=alkyl; Mₙ=K, Na, Li) wherein R is alkyl, aryl, substituted alkyl, or substituted aryl.

Typical initiators include protic compounds such as alcohols (ROH), di-alcohols (HO—R—OH), polyols (compounds containing more than two OH groups, or sugars; amines (RNH₂, R₂NH); thiols (RSH), where R is alkyl, aryl, substituted alkyl, or substituted aryl, or deprotonated monomers.

Polycondensation reactions are typically carried in-neat under elevated temperatures and vacuum, in one or more stages (with progressively increased temperature and vacuum) as needed, in the presence of a catalyst. Typical catalysts are Sn(Oct)₂, Ti(OⁿBu)₄, and metal-based and organic catalysts outlined above.

Embodiments of Depolymerization Processes: The above catalysts for polymerization and other compounds can also be used as catalysts for depolymerization at elevated temperatures (typically from 100 to 250° C.) to recover the monomer via distillation, sublimation, etc. For example, catalysts can be inorganic bases such as M^{I}(OH) (Mₙ=Na, K) and M^{II}(OH)₂ (Mₙ=Mg, Ca), inorganic Lewis acids such as ZnCl₂, organic acids such as para-toluenesulfonic acid (p-TsOH), camphorsulfonic acid (CSA), DOWEX 50W-X8 resin-hydrogen form, and organic base/acid adducts (salts).

### Results and Discussion

The three long-standing challenges facing PHAs that must be addressed before broad commercial implementation and applications can be realized are described as follows. First, current PHAs are intrinsically thermally unstable, with a relatively low degradation temperature (T_{d}, the temperature at 5% weight loss) of ˜250° C., owing to the presence of α-hydrogens that promote facile cis-elimination via the six-membered transition state to form an internal alkene and a carboxylic acid (Chart 2), causing a large, continuous drop in shear viscosity under melt-processing conditions (e.g., Shear viscosity (shear rate r*=1 s⁻¹) in melt at 180° C. of it-P3HB (M, =111 kDa), showed a large, continuous drop in viscosity over 30 min owing to rapid degradation). Second, the mechanical performance of PHAs is generally inferior to that of commonly used plastics; for example, it-P3HB is extremely brittle with an elongation at break (e_{b}) ˜4%, which is much lower than that of it-PP (e_{b}>400%). Third, synthetic PHAs lack the de-sired closed-loop chemical recyclability. For example, the acid-catalyzed depolymerization of P3HB leads to formation of cyclic oligomers (which can be repolymerized to only oligomers with Mₙ˜5 kDa), rather than its readily polymerizable monomer b-BL or 8DL^{Me} to close the loop, whereas the base-catalyzed depolymerization yields crotonic acid. Although biodegradability in the ambient environment is a distinct advantage of PHAs for protecting our environment if they are disposed there, they should not be landfilled as accumulation of degraded intermediates and eventual CO₂ will cause un-intended environmental and climate problems. Additionally, the inability to recover the PHA building blocks represents a considerable loss of energy and resources that are still endowed in the postconsumer PHAs. Hence, it is critical to install the chemical circularity to the biodegradable PHAs toward an ultimate goal of establishing a circular plastics economy.

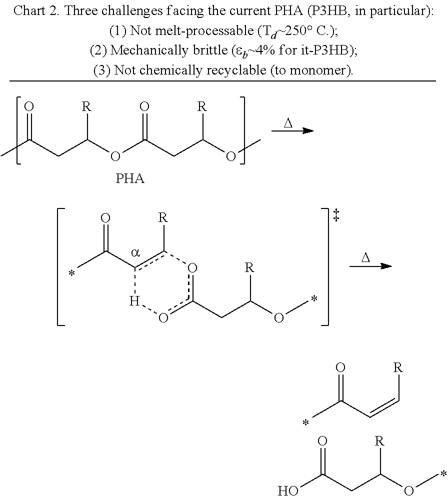

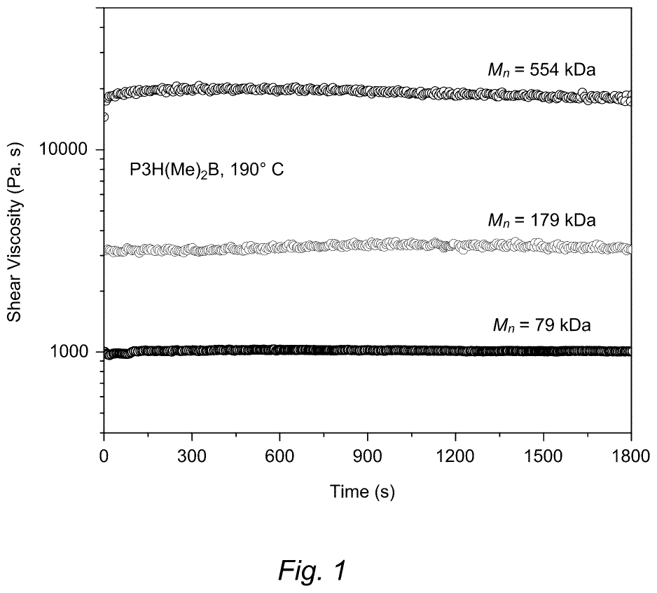

Strategies to suppress thermal degradation and achieve melt processability. A straightforward strategy to suppress thermal degradation due to cis-elimination enabled by α-hydrogens in conventional PHAs is to substitute both α-hydrogens with alkyl or aryl groups. When substituting only one α-hydrogen in the parent P3HB with a methyl group, the resulting poly(3-hydroxy-2-methylbutyrate) indeed shows improved thermal stability, but only by ˜20° C. relative to the P3HB used in that study. However, substituting both α-hydrogens yields poly(3-hydroxy-2,2-dimethylbutyrate) [P3H(Me)₂B], the thermal and mechanical properties of which are drastically enhanced: P3H(Me)₂B is not only semicrystalline, with high Tₘ's of 167° to 243° C. as well as being thermally stable with high Ta's of 314° to 335° C. (i.e., 56° to 85° C. enhancement) and melt-processable, but also ductile, with e_{b}>200% (Chart 3 and FIG. 1). Moreover, P3H(Me)₂B can be chemically recycled back to its starting monomer, α,α-dimethyl-β-butyrolactone [(Me)₂BL], which is used in the chain-growth ROP, or 3-hydroxy-2,2-dimethylbutyric acid [3H(Me)₂BA], which is used in the step-growth polycondensation (SGP), thus accomplishing closed-loop chemical recyclability (Chart 3). Poly(3-hydroxy-2,2-dimethylpropionate), P3H(Me)₂P (Mₙ=162 kDa, prepared from the ROP of α,α-dimethyl-b-propiolactone, Table 1) also exhibits high T_{d} (up to 373° C.) and Tₘ (up to 232° C.) values, but it is extremely brittle with e_{b}<4%. The ROP of (Me)₂BL (prepared from highly reactive dimethyl ketene and acetaldehyde) was attempted, but only oligomeric species (Mₙ=2.9 kDa) were obtained in 35% yield after 10 days. The method reported herein enabled the rapid synthesis of high-molar mass P3H(Me)₂B in quantitative yield and with Mₙ up to 554 kDa, Tₘ up to 243° C., and T_{d} up to 335° C. Overall, such thermal robustness of α,α-dimethylated PHAs enables their melt processability, de-spite further enhanced Tₘ values, and such PHAs exhibit the desired chemical circularity through closing the monomer-polymer-monomer loop.

TABLE 1
Results of ROP of (Me)₂PL, (Me)₂BL and (Et)₂BL.

| | | | [M]/ | Solvent | Temp. | Time | Conv. | Mₙ ^{c} | |
|---|---|---|---|---|---|---|---|---|---|
| Run ^{a} | Monomer | Catalyst | [Cat.]/[I] | (mol/L) | (° C.) | (h) | (%) ^{b} | (kDa) | Ð ^{c} |
| 1 | (Me)₂PL | ^{t}Bu—P₄ | 6400:1:1 | neat | 70 | 1 | 99 | 162 | 1.43 |
| 2 | (Me)₂BL | TBD | 100:1:1 | neat | rt | 12 | 0 | — | — |
| 3 | (Me)₂BL | DBU | 100:1:1 | neat | rt | 18 | 0 | — | — |
| 4 | (Me)₂BL | DBU | 100:1:1 | neat | 70 | 12 | 89 | 5.6 | 1.04 |
| 5 | (Me)₂BL | DBU | 400:1:1 | DCM, 3M | 70 | 12 | 0 | — | — |
| 6 | (Me)₂BL | ^{t}Bu—P₄ | 400:1:1 | neat | 70 | 0.5 | 99 | 21.9 | 1.11 |
| 7 | (Me)₂BL | ^{t}Bu—P₄ | 800:1:1 | THF, 2M | 70 | 20 | 99 | 43.0 | 1.05 |
| 8 | (Me)₂BL | ^{t}Bu—P₄ | 800:2:1 | THF, 2M | 70 | 20 | 99 | 22.1 | 1.02 |
| 9 | (Me)₂BL | ^{t}Bu—P₄ | 800:0.5:1 | THF, 2M | 70 | 12 | 99 | 179 | 1.04 |
| 10 | (Me)₂BL | ^{t}Bu—P₄ | 5000:0.5:1 | THF, 2M | 70 | 12 | 99 | 554 | 1.06 |
| 11 | (S)-(Me)₂BL | ^{t}Bu—P₄ | 800:0.5:1 | THF, 2M | 70 | 12 | — | 34.9 | 1.15 |
| 12 | (Et)₂BL | ^{t}Bu—P₄ | 800:0.5:1 | THF, 2M | 70 | 10 | 99 | 190 | 1.05 |
| 13 | (Et)₂BL | ^{t}Bu—P₄ | 5000:0.5:1 | THF, 2M | 70 | 40 | 94 | 468 | 1.18 |
| 14 d | (Me)₂/(Et)₂BL | ^{t}Bu—P₄ | 2500:2500:0.5:1 | THF, 2M | 70 | 40 | 99(Me), | 293 | 1.14 |
| | (50:50) | | | | | | 87(Et) | | |

^{a} Conditions: Monomer (M) (1 mmol), initiator (I) = BnOH, room temperature (rt, ~23° C.).
^{b} Determined by ¹H NMR in CDCl₃ or d-HFIP.
^{c} Number-average molar mass (Mₙ) and dispersity index (Ð = M_{w}/Mₙ) determined by size exclusion chromatography (SEC) at 40° C. in CHCl₃ or HFIP coupled with a DAWN HELEOS II multi-angle light scattering detector and an Optilab TrEX dRI detector for absolute molar mass.
d (Me)₂BL (4 mmol), (Et)₂BL (4 mmol).

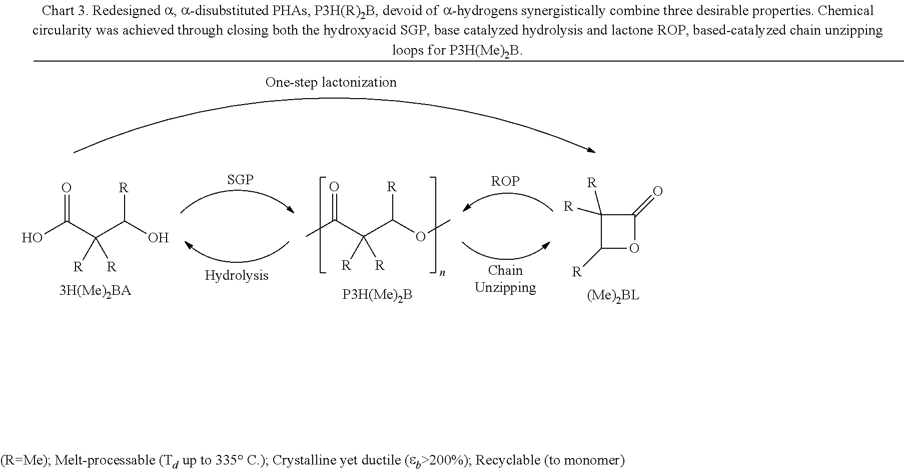

Dual closed loops to achieve chemical circularity. The α,α-dimethylated PHA can be synthesized through either the SGP of hydroxyacid (HA) 3H(Me)₂BA or the ROP of lactone (Me)₂BL (Chart 3). The HA, 3H(Me)₂BA, was obtained in one step from acetaldehyde, which is produced at a large industrial scale and can also be bio-sourced, and isobutyric acid, a commercial chemical that can be obtained biologically from glucose, in 88% yield (see materials and methods for its synthesis at 362-g scale from methyl isobutyrate), whereas the lactone (Me)₂BL was prepared via one-step lactonization of the HA [e.g., 232 g of (Me)₂BL was prepared in 93% yield]. The diethyl derivative, (Et)₂BL, was synthesized by use of the same lactonization method. Notably, the HA and lactone monomers can be prepared or re-covered in good to quantitative yields from selective depolymerization of the PHA (see below).

At the outset, the ROP of (Me)₂BL (as a racemate) was explored by using different organic base catalysts and reaction conditions, and the ROP was optimized with superbase catalyst ^{t}Bu-P₄ {1-tert-butyl-4,4,4-tris(dimethyl-amino)-2,2-bis[tris(dimethylamino)phospho-ranyliden-amino]2l⁵,4l⁵-catenadi(phosphazene)} in tetrahydrofuran (THF) at 70° C. (Table 1). Thus, the ROP in THF, with ^{t}Bu-P₄ as the catalyst and benzyl alcohol (BnOH) as the initiator, afforded P3H(Me)₂B with low Mₙ (22.1 kDa, Ð=1.02) to medium Mₙ (43.0 kDa, Ð=1.05) to high Mₙ (179 kDa, Ð=1.04; 554 kDa, Ð=1.06). Likewise, the ROP of (Et)₂BL in THF also led to the corresponding high-molar mass P3H(Et)₂B (Mₙ=468 kDa, Ð=1.18) in near-quantitative yield (Table 1). In a separate set of experiments that investigated the degree of control in the ROP, the molar mass was found to increase linearly with an increase of the [(Me)₂BL]/[^{t}Bu-P₄] ratio from 200:1 to 1600:1, whereas the dispersity of the resulting P3H(Me)₂B remained extremely narrow (Ð≤1.04), indicating the well-controlled ROP of (Me)₂BL. The scalability of this ROP was tested in a polymerization using 125 g of (Me)₂BL under industrially relevant conditions: with a low catalyst loading [55 parts per million (ppm) ^{t}Bu-P₄], neat (solvent-free), and at 70° C. This scaled-up run achieved 96% monomer conversion and afforded 115 g of the pure P3H(Me)₂B in a 92% isolated yield.

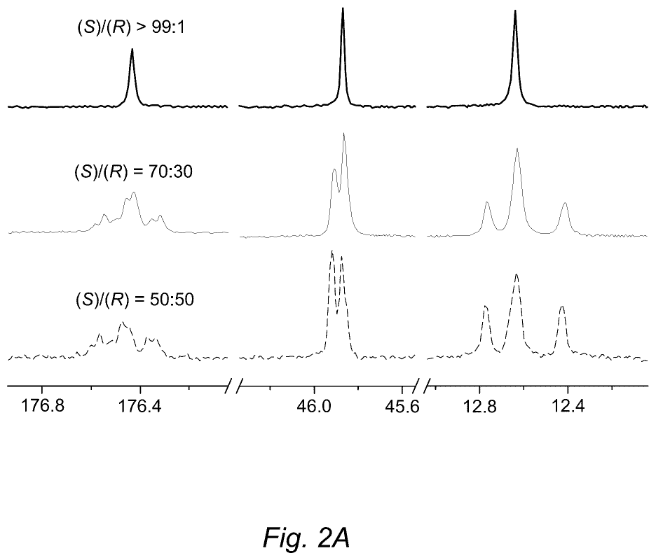

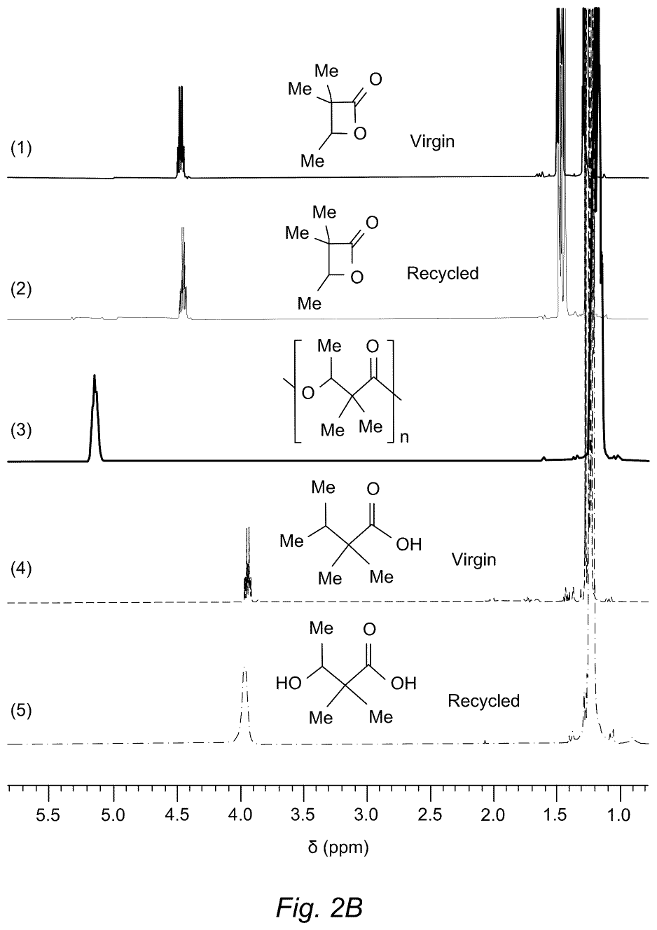

To prepare a purely isotactic polymer sample for stereomicrostructural and thermal property analysis, we synthesized (S)-P3H (Me)₂B (Mₙ=34.9 kDa, Ð=1.15) via the ROP of enantiopure (S)-(Me)₂BL. The perfect tacticity was characterized by the presence of only one carbonyl signal at 176.4 ppm and also a single signal at 46.9 and 12.6 ppm in ¹³C nuclear magnetic resonance (NMR) spectra for the quaternary and methyl carbons, respectively (FIG. 2A). In comparison, the P3H(Me)₂B derived from (Me)₂BL with a 70:30 (S)/(R) ratio showed multiple signals in those regions, but most informatively, the new minor signal appeared at 45.91 ppm next to the 45.87-ppm major signal, indicative of an iso-rich tacticity. As predicted, those two signals present in the P3H(Me)₂B that was prepared from a 50:50 (S)/(R) ratio are approximately in equal abundance (FIG. 2A), indicating an atactic structure.

We envisioned another synergistic benefit of α,α-disubstitution that could endow the α,α-dialkylated PHA with chemical recyclability by direct depolymerization to its monomer, enabled by the gem-disubstituted Thorpe-Ingold effect that promotes ring closure and stabilization of strained rings. At the outset, depolymerization of a ROP-derived P3H(Me)₂B sample was screened at temperatures below 240° C. under vacuum with different base catalysts (Table 2), affording (Me)₂BL and side-product 2-methyl-2-butene with different ratios. For example, heating the sample with NaOH (5 wt. %) at 210° C. under vacuum recovered the pure (Me)₂BL monomer in 60% isolated yield (FIG. 2B) after the quick release of 2-methyl-2-butene as a gas, which was also recovered and could be reused. Next, through consecutive polymerization-depolymerization cycles, we achieved the circular monomer-polymer-monomer loop. The second pathway to establish the closed-loop chemical recycling is through hydrolytic depolymerization of the PHA to the HA. For example, hydrolysis of P3H(Me)₂B (Table 3) by aqueous LiOH enabled its de-polymerization to form pure 3H(Me)₂BA in quantitative yield (FIG. 2B). The recovered HA can be transformed to (Me)₂BL via one-step lactonization (Chart 3). (Me)₂BL can also be obtained through NaOH (2 wt %)-catalyzed depolymerization of the oligomeric P3H(Me)₂B prepared through the SGP of 3H(Me)₂BA catalyzed by BF₃·OEt₂ (Chart 3). These results demonstrate that the SGP of the HA can be used to obtain oligomers or polymers with low to medium molar mass, which are effectively depolymerized to form the lactone for the rapid ROP to high-molar mass PHAs.

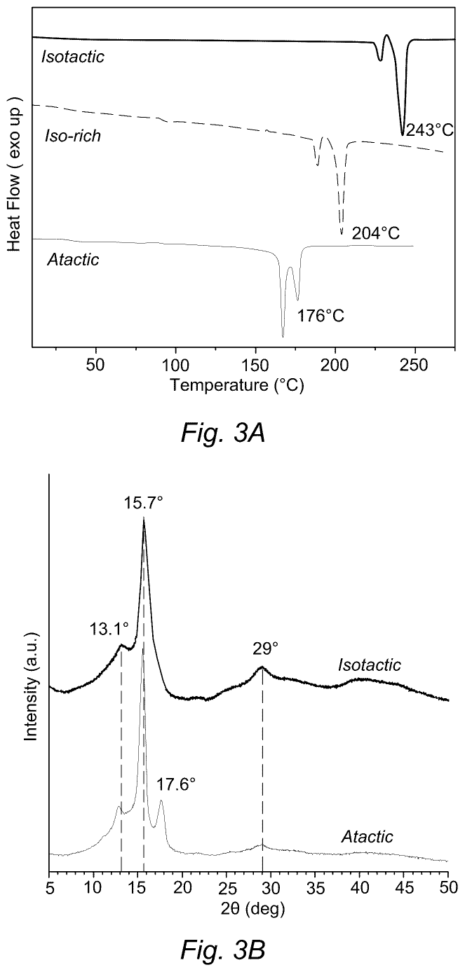

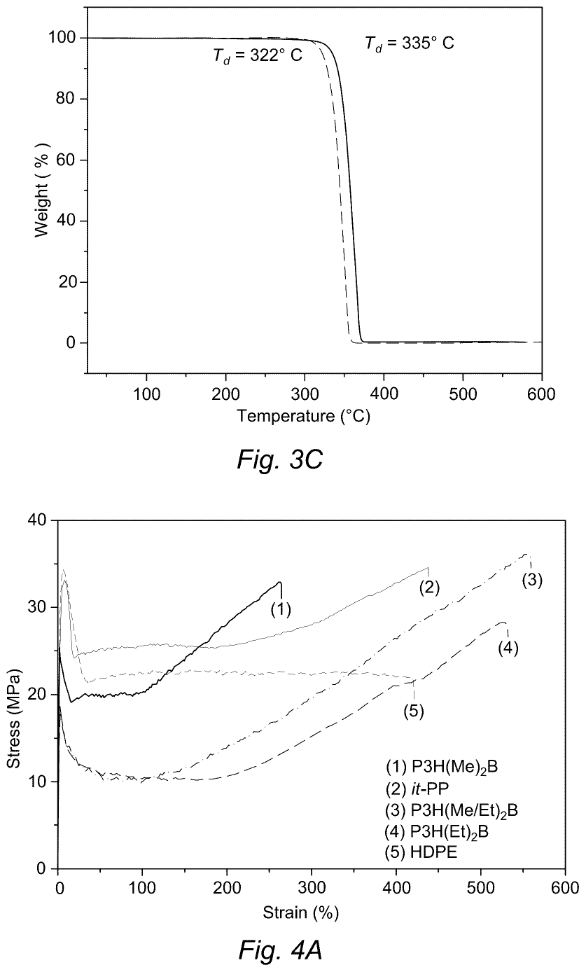

Thermal properties and tacticity-independent (intrinsic) crystallinity. The isotactic (R)-P3H(Me)₂B exhibits a notably high Tₘ of 243° C. (FIG. 3A), which is 68° C. higher than that of (R)-P3HB (Tₘ=175° C.). Moreover, the atactic at-P3H(Me)₂B, which is produced by the ROP of rac-(Me)₂BL catalyzed by the achiral organic catalyst ^{t}Bu-P₄, is also semicrystalline, with Tₘ values of 167° C. and 176° C. (FIG. 3A). Thus, P3H(Me)₂B adds to rare examples of polymers exhibiting tacticity-independent crystallinity—a class of polymers that are intrinsically semicrystalline, having a similar degree of crystallinity regardless of the backbone tacticity, although the absolute Tₘ value varies as the tacticity changes. To probe the possibility of stereocomplex formation, we prepared a 1:1 physical blend of enantiomerc it-polymers derived from enantiomeric monomers, (R)-(Me)₂BL and (S)-(Me)₂BL, and found the resulting blend to display the same thermal properties as the homochiral polymers, suggesting the absence of stereocomplexation. Furthermore, the iso-rich P3H(Me)₂B derived from (Me)₂BL with a 70/30 (S)/(R) ratio showed Tₘ values of 189° C. and 204° C., which are between those of the it- and at-P3H(Me)₂B samples (FIG. 3A).

TABLE 2
Results of depolymerization of P3H(Me)₂B (Mₙ = 13.1 kDa, Ð = 1.04).

| | Temp. | Cat. | Time | Conversion | Recyclability (%) |
|---|---|---|---|---|---|
| Polymer ^{a} | (° C.) | (wt %) | (h) | (%) ^{b} | (Me)₂BL/2,3-dimethyl-2-butene |
| P3HB | No recyclability to BL, recycled to cyclic trimer or crotonic acid | | | | |
| P3H(Me)₂B | 240 | — | 10 | 34 | 0:0 |
| P3H(Me)₂B | 240 | KOH (5%) | 10 | 91 | 59:41 |
| P3H(Me)₂B | 240 | LiOH (5%) | 10 | 94 | 48:52 |
| P3H(Me)₂B | 240 | NaOH (5%) | 10 | 99 | 64:36 (60) ^{c} |
| P3H(Me)₂B ^{d} | 210 | NaOH (5%) | 10 | 99 | 60 ^{c} |
| P3H(Me)₂B | 240 | Mg(OH)₂ (100%) | 1 | 99 | 21:79 |
| P3H(Me)₂B | 240 | KH (5%) | 3 | 99 | 42:58 |
| P3H(Me)₂B | 240 | CsOH (5%) | 10 | 99 | 21:79 |
| P3H(Me)₂B | 240 | Ca(OH)₂ (5%) | 10 | 99 | 28:72 |
| P3H(Me)₂B | 150 | KOH (5%) | 10 | 15 | 54:46 |
| P3H(Me)₂B | 240 | Li₂O (5%) | 10 | 80 | 56:44 |
| P3H(Me)₂B | 240 | LiCl (5%) | 10 | 92 | 43:57 |
| P3H(Me)₂B | 240 | KF (5%) | 10 | 82 | 34:66 |
| P3H(Me)₂B | 240 | NaCl (5%) | 10 | 48 | 38:62 |
| P3H(Me)₂B | 240 | K₂CO₃ (5%) | 10 | 92 | 36:64 |

^{a} Conditions: P3H(Me)₂B (1 mmol, 114 mg), reacted in a heating mantle.
^{b} Determined by weight differences of the glass reactor (polymer & stir bar) before and after the reaction.
^{c} Isolated yield.
^{d} Reacted in oil bath.

TABLE 3
Results of hydrolytic depolymerization of P3H(Me)₂B
(Mₙ = 21.9 kDa, Ð = 1.11).

| | | | NMR yield (%) ^{b} |
|---|---|---|---|
| | | Time | (Isolated |
| Run ^{a} | Condition | (h) | 3H(Me)₂BA yield) |
| 1 | KOH (4N, 2 mL), THF/MeOH (8/0.5 mL), 100° C. | 108 | 62 |
| 2 | KOH (4N, 4 mL), THF/MeOH (4/0.5 mL), 100° C. | 72 | 17 |
| 3 | LiOH (4N, 4 mL), THF/MeOH (4/0.5 mL), 100° C. | 72 | 99 (99) |
| 4 | KOH (4N, 8 mL), Tol. (8 mL), 100° C. | 41 | 13 |
| 5 | HAc/HCl (2/2 mL), 100° C. | 41 | 0 |

^{a} Conditions: P3H(Me)₂B (100 mg).
^{b} Yield was determined by ¹H NMR in CDCl₃.

The two melting peaks observed in all the melt-crystallized P3H(Me)₂B samples present in the second heating scan (but not in the first heating scan) on the differential scanning calorimetry (DSC) thermograms, which be-come more pronounced as the tacticity de-creases (FIG. 3A), could be due to the melting of two different polymorphic forms crystallized by cooling from the melt; to a transformation between two different crystalline forms; or simply to melting and recrystallization into the same crystalline form. To clarify this point, three DSC experiments with second heating scans performed at different heating rates (2.5, 10, and 20° C./min) were carried out. The decrease in the area of the higher Tₘ peak and the simultaneous increase in the area of the lower Tₘ peak with increasing the heating rate suggest that the two peaks are not due to the melting of two different crystalline phases formed upon cooling from the melt, but rather indicate that melting and recrystallization phenomena occur during heating. To further test this hypothesis, we also collected wide-angle x-ray scattering (WAXS) profiles at different temperatures during heating of the melt-crystallized sample, showing the identical profiles between those collected at room temperature before the first heating scan and after the crystallization from the melt. These results confirm the absence of two different polymorphic forms and suggest that the two melting peaks are due to melting at nearly 167° C. to 169° C. and fast recrystallization of the melt with formation of more ordered and thick crystals of the same crystalline form that melt at higher temperatures of 177° C. to 181° C. The result that the temperatures of both melting peaks in-crease with decreasing heating rate is a further confirmation of the occurrence of recrystallization during heating.

The WAXS profile of the as-synthesized at-P3H(Me)₂B (Mₙ=554 kDa) displays three major diffraction peaks centered at 2q≈13.1°, 15.7°, and 17.6°, and other minor diffraction peaks of much lower intensities at higher 2q values (FIG. 3B), with the calculated crystallinity (x_{c}) of 67%. When the as-synthesized it- and at-P3H(Me)₂B materials are compared, they display essentially the same main diffraction peaks with slightly different intensities at the higher 2q region (FIG. 3B); indeed, the degree of crystallinity of at-P3H(Me)₂B (x_{c}=67%) was found to be even higher than that of it-P3H(Me)₂B (x_{c}=58%). To under-stand the origin of crystallinity manifested in at-P3H(Me)₂B, we performed conformational analysis, first on chain models of it-P3H(Me)₂B with opposite chirality-namely, (R)-P3H(Me)₂B and (S)-P3H(Me)₂B— and then extended to a chain model of at-P3H(Me)₂B characterized by a random succession of R and S units along the chain. Oriented fibers of at-P3H(Me)₂B were obtained by stretching the compression-molded sample at ˜150° C. and annealing the fiber under tension at 143° C. for 35 min. The two-dimensional x-ray fiber diffraction pattern of at-P3H(Me)₂B reveals three strongest reflections that are polarized on the equator and centered at the same 2q position as those observed in the powder profile (FIG. 3B). These results indicate that the fiber is crystallized in the same crystalline form of the as-prepared and melt-crystallized samples and that upon stretching, no polymorphic transformations occur. Other reflections are polarized on the first layer line and further weak reflections on the second layer line. From the separation between the different layer lines observed in the fiber pattern, a value of the chain axis c of 4.66 Å was determined. This value is consistent with a transplanar conformation corresponding to one of the energy minima found by the conformational analysis. Overall, this study showed that the shape of the chain and the projection normal to the chain axis of at-P3H(Me)₂B are very similar to the ordered models of the R-enantiomer, which explains the fact that the at-P3H(Me)₂B chains can crystallize, despite the configurational disorder, and that the at-P3H(Me)₂B shows a WAXS profile similar to that of the pure enantiomeric (R)-P3H(Me)₂B. Indeed, they likely crystallize in the same crystalline form (FIG. 3B).

The thermal stability of the PHA samples was analyzed and compared by thermogravimetric analysis (TGA). Despite the largely different Tₘ values between it- and at-P3H(Me)₂B materials, they displayed similarly high T_{d} values of 322° C. and 335° C., respectively (FIG. 3C). These values are considerably higher than the T_{d} value (˜250° C.) of it-P3HB. The molar mass has a substantial effect on Ta, but it hardly affects Tₘ. For example, the T_{d} of P3H(Me)₂B increased from 314° C. to 335° C. as the Mₙ increased from 179 to 554 kDa, whereas the Tₘ remained the same.

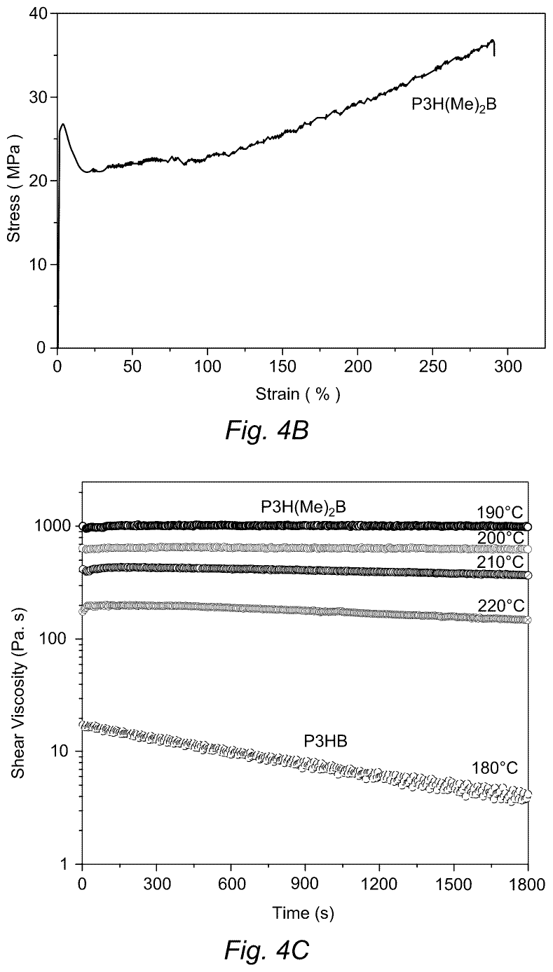

Mechanical and rheological properties. When compared to it-P3HB (e_{b}˜4%), semi-crystalline at-P3H(Me)₂B (Mₙ=554 kDa) dis-plays a significantly enhanced ductility (e_{b}=228±24.6%), a higher elastic modulus (E=2.94±0.40 GPa), and a higher stress (s=31.6±1.8 MPa), showing that the α,α-dimethyl substitution also overcomes the brittleness of it-P3HB (FIG. 4A, Table 4). With incorporation of more flexible diethyl groups, P3H(Et)₂B achieved further enhanced ductility with e_{b}=501±36%, while maintaining a high modulus of E=1.22±0.27 GPa (FIG. 4A, Table 5). The Me/Et random copolymer P3H(Me/Et)₂B, synthesized by copolymerizing (Me)₂BL and (Et)₂BL, exhibited an even higher fracture strain (e_{b}=517±35%) and stress (s=34.1±2.1 MPa) relative to P3H(Et)₂B, which outperformed both high-density PE (HDPE) and it-PP (FIG. 4A, Table 6). Also, the mechanical performance of the P3H(Me)₂B material (Mₙ=332 kDa) prepared from a large (115 g)-scale run was further improved relative to the polymer prepared at 5-g scale, exhibiting higher elastic modulus (E=3.08±0.18 GPa), stress (s=33.9±2.1 MPa), and ductility (e_{b}=252±30.1%) (FIG. 4B, Table 7). These results further indicate the scalability of the polymerization to produce high-performance P3H(Me)₂B.

TABLE 4
Tensile data for P3H(Me)₂B (Mₙ = 554 kDa)
produced by a [(Me)₂BL]/[^{t}Bu—P₄]/
[BnOH] ratio of 5000:0.5:1.

| | Stress | Strain | Modulus | Toughness |
|---|---|---|---|---|
| Entry | (MPa) | (%) | (GPa) | (MJ m⁻³) |
| 1 | 31.1 | 215 | 2.72 | 56 |
| 2 | 32.9 | 220 | 3.52 | 56 |
| 3 | 29.2 | 211 | 2.65 | 50 |
| 4 | 33.0 | 264 | 2.86 | 64 |
| Average | 31.6 | 228 | 2.94 | 57 |
| Std. dev. | 1.8 | 24.6 | 0.40 | 6 |

TABLE 5
Tensile data for P3H(Et)₂B (Mₙ = 468 kDa)
produced by a [(Et)₂BL]/[^{t}Bu—P₄]/
[BnOH] ratio of 5000:0.5:1.

| | Stress | Strain | Modulus | Toughness |
|---|---|---|---|---|
| Entry | (MPa) | (%) | (GPa) | (MJ m⁻³) |
| 1 | 28.3 | 527 | 1.05 | 83 |
| 2 | 26.5 | 515 | 1.53 | 77 |
| 3 | 27.0 | 460 | 1.08 | 76 |
| Average | 27.3 | 501 | 1.22 | 79 |
| Std. dev. | 0.9 | 36 | 0.27 | 4 |

TABLE 6
Tensile data for P3H(Me/Et)₂B (Mₙ = 293 kDa)
produced by a [(Me)₂BL]/[(Et)₂BL]/[^{t}Bu—P₄]/
[BnOH] ratio of 2500:2500:0.5:1.

| | Stress | Strain | Modulus | Toughness |
|---|---|---|---|---|
| Entry | (MPa) | (%) | (GPa) | (MJ m⁻³) |
| 1 | 32.2 | 480 | 1.40 | 88 |
| 2 | 32.3 | 499 | 1.85 | 85 |
| 3 | 35.6 | 527 | 1.56 | 98 |
| 4 | 36.2 | 560 | 2.07 | 113 |
| Average | 34.1 | 517 | 1.80 | 96 |
| Std. dev. | 2.1 | 35 | 0.28 | 13 |

TABLE 7
Tensile data for P3H(Me)₂B (115 g scale, Mₙ =
332 kDa) produced by a [(Me)₂BL]/[^{t}Bu—P₄]/
[BnOH] ratio of 10000:0.5:1 in neat conditions.

| | Stress | Strain | Modulus | Toughness |
|---|---|---|---|---|
| Entry | (MPa) | (%) | (GPa) | (MJ m⁻³) |
| 1 | 36.8 | 290 | 3.21 | 78 |
| 2 | 33.2 | 264 | 3.25 | 66 |
| 3 | 34.0 | 230 | 2.90 | 62 |
| 4 | 31.7 | 226 | 2.96 | 57 |
| Average | 33.9 | 252 | 3.08 | 66 |
| Std. dev. | 2.1 | 30.1 | 0.18 | 9 |

The third synergy as a result of removing the two cis-elimination-prone α-protons by α,α-dialkyl substitution to enhance the PH4 Å thermal stability in the solid state is the realization of melt processability. To test the possibility of melt processing, we monitored the shear viscosity change over time for P3H(Me)₂B at temperatures above Tₘ in a continuous-flow mode at a shear rate of 1 s⁻¹. As a reference, it-P3HB (Mₙ=111 kDa, Tₘ=170° C.) was also subjected to the same shear viscosity test in melt (180° C.). The shear viscosity for P3H(Me)B (M=79 kDa) remained constant without any obvious decrease over a time frame of 30 min at temperatures up to 210° C. (FIG. 4C), which is well above the corresponding melting temperature. Furthermore, P3H(Me)₂B samples with a wide molar mass range, from Mₙ=79 to 554 kDa, behaved similarly and showed a stable shear viscosity at 190° C. over the same time period (FIG. 1), further demonstrating melt-processing feasibility. By contrast, it-P3HB, known for rapid degradation in melt, displayed a substantial decay in its shear viscosity, from 17 to 4 Pa s (76%), after 30 min at 180° C. (FIG. 4C). P3H(Me)₂B (Mₙ=79 kDa) evidenced a small but noticeable decrease in its shear viscosity at 220° C., indicating its upper-limit melt-processing temperature (FIG. 4C). Overall, the studies in shear viscosity presented here consolidate the effectiveness of the strategy of removing the α-protons of the PHA repeat units to enhance their thermal stability and enable their melt processability.

A large body of studies have focused on fine-tuning the PHA thermal and mechanical properties by varying the main-chain com-positions and stereomicrostructures, as well as the b-pendent group chain length and functionality, achieving notable success in addressing some aspects of the PHA's long-standing challenges but leaving inherent issues with thermal stability and chemical circularity unresolved. The α,α-dialkylated PHA platform described in this study is designed to address the root cause of the PHA thermal instability—the facile cis-elimination process during thermal degradation involving the α-hydrogens in the repeat units—by substituting both α-hydrogens with alkyl groups. This simple α,α-dialkyl substitution not only enhances the thermal stability so substantially that the PHAs become melt processable but also synergistically endows the PHAs with the high ductility and toughness that are comparable with or superior to it-PP and HDPE. Furthermore, this platform offers ease of synthesis as, in contrast to the parent P3HB, the α,α-dimethylated P3H(Me)₂B is always semicrystalline, regard-less of its tacticity, thanks to its fascinating tacticity-independent, intrinsic crystallinity, thereby allowing for the synthesis of semi-crystalline high-performance PHAs without the need to control the polymerization stereo-chemistry that often requires specifically de-signed chiral catalysts. Above all, this design achieves chemical circularity through closing both the ROP and SGP loops in PHA production and chemical recycling to monomer, there-by solving the three challenges facing the current PHAs.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Materials and Methods

All syntheses and manipulations of air- and moisture-sensitive materials were carried out in flamed Schlenk-type glassware on a dual-manifold Schlenk line, on a high-vacuum line, or in an inert gas (Ar or N₂)-filled glovebox. High-performance liquid chromatography (HPLC)-grade organic solvents were first sparged extensively with nitrogen during filling 20 L solvent reservoirs and then dried by passage through activated alumina (for tetrahydrofuran (THF) and dichloromethane (DCM)) followed by passage through Q-5 supported copper catalyst (for toluene and hexanes) stainless steel columns. For the THF used in polymerization reactions, HPLC-grade THF was degassed and dried over sodium and benzophenone for 12 h, followed by vacuum distillation. 1,5,7-Triazabicyclo[4.4.0]dec-5-ene (TBD) was purchased from TCI Chemical Co., and ^{t}Bu-P₄ (0.8 M in hexane) was purchased from Sigma-Aldrich Chemical Co.; both catalysts were used as received. 3-Hydroxy-2,2-dimethylpropionic acid [3H(Me)₂PA] purchased from Oakwood Chemical Co. was purified by sublimation. Sodium hydroxide purchased from Fisher Scientific Co., boron trifluoride diethyl etherate purchased from TCI Chemical Co. was used in the glovebox directly. Benzyl alcohol (BnOH) and 1,8-diazabicyclo[5.4.0]undec-7-ene (DBU) were purchased from Fisher Scientific Co. and Sigma-Aldrich Chemical Co., respectively, and purified by distillation over CaH₂ and stored over activated Davison 4 Å molecular sieves. Isotactic polypropylene (it-PP, 5 mm gran., Mₙ=97.0 kDa) and high-density polyethylene (HDPE, 2-4 mm gran., MFI=7.6) were purchased from Sigma-Aldrich and Goodfellow, respectively. All other chemicals were purchased from their respective commercial sources (isobutyric acid, 2-ethylbutyric acid, 3-chloropivalic acid were purchased from TCI Chemical Co.; (R)/(S) methyl 3-hydroxybutanoate were purchased from AmBeed Co.; methyl isobutyrate, n-butyl lithium (1.6 M), diisopropylamine, benzenesulfonyl chloride, triethylamine, iodomethane, paraformaldehyde were purchased from Oakwood Chemical Co.; acetaldehyde was purchased from Acros Organics Co.) and used as received.

### General Polymerization Procedures.

For P3H(Me)₂P. ROP reactions were performed in 10 mL Schlenk flasks inside an inert glovebox at ambient temperature (˜23° C.). A mixture of base catalyst and alcohol initiator indicated in the polymerization tables was stirred at ambient temperature for 10 min, and then a predetermined amount of lactone monomer (Me)₂PL was added. The sealed reactors were taken out from the glove box and stirred at 70° C. After a desired time period, the mixture turned into solid, and a sample was taken from the reaction mixture and prepared for ¹H NMR analysis to obtain the percent monomer conversion data. Then the polymerization was quenched by addition of benzoic acid in CHCl₃ (5 mg/mL) and dissolved with 1,1,1,3,3,3-hexafluoro-2-propanol (HFIP), followed by precipitation in methanol for 2-3 times. After filtration, the white polymer solid was dried in vacuo at 60° C. to a constant weight.

For P3H(R)₂B, R=Me, Et. ROP reactions were performed in 10 mL Schlenk flasks or 5.5 mL glass reactors inside an inert glovebox at ambient temperature (˜23° C.). A mixture of catalyst and initiator (indicated in polymerization Table 1) in THF was stirred at ambient temperature for 10 min, and then a predetermined amount of lactone monomer (R)₂BL was added. The sealed reactors were taken out from the glove box and stirred at 70° C. After a desired time period, the mixture became sticky and an aliquot was taken from the reaction mixture and prepared for ¹H NMR analysis to obtain the percent monomer conversion data. The polymerization was quenched by addition of benzoic acid in chloroform (5 mg/mL) and dissolved with DCM [or HFIP for isotactic (S)-P3H(Me)₂B], followed by precipitation in methanol for 2-3 times. After filtration, the white polymer solid was dried in vacuo at 60° C. to a constant weight.

Polycondensation reactions were performed in a sealed Schlenk flask containing 3H(Me)₂BA (660 mg, 5 mmol) and BF₃·OEt₂ (62 uL, 0.5 mmol). The flask was stirred at 160° C. for 22 h, then a vacuum of 200 mTorr was applied to the polycondensation set-up for another 2 h. After being cooled to room temperature, the mixture became sticky and an aliquot was taken from the reaction mixture for ¹H NMR analysis. The dark brown mixture was dissolved with DCM/water and extracted with DCM (10 mL×3). The combined organic layers were washed with brine, dried over Na₂SO₄, and then evaporated in vacuo. The resultant oligomeric P3H(Me)₂B (353 mg, 62% yield) was directly used for the depolymerization to (Me)₂BL.

Chemical recycling to lactone monomer (Me)₂BL. In a separate depolymerization experiment, to a 5.5 mL glass reactor equipped with a stir bar was added NaOH or other catalyst as indicated in Table 2 (5.7 mg, 5 wt %) and P3H(Me)₂B (0.114 g, 1 mmol) obtained by the ROP of (Me)₂BL. The mixture was heated at 210° C. (oil bath) and distilled under vacuum with a receiving flask cooled under liquid nitrogen. After the powder disappeared, two methods were applied to analyze the depolymerization product. In the first method, CDCl₃ was added to the receiving flask from the distilled head when the receiving flask's temperature was still low and then the ratio of the recycled monomer (Me)₂PL and 2-methyl-2-butene was analyzed by ¹H NMR. In the second method, the vacuum was turned off and the cold bath was removed. As the flask was warmed to room temperature, a colorless liquid was received (2-methyl-2-butene became gas), which was confirmed to be the recycled, pure monomer (Me)₂BL (60% isolated yield) by ¹H NMR analysis. When oligomeric P3H(Me)₂B obtained from the polycondensation was used for depolymerization, the recycled monomer (Me)₂BL (48% yield) was obtained through reaction with NaOH (2 wt %) at 190° C.

Chemical recycling to HA monomers 3H(Me)₂BA. In a separate depolymerization experiment, a solution of P3H(Me)₂B (100 mg) and aqueous LiOH (384 mg, 4 mL H₂O) in THF/MeOH (4/0.5 mL) was reacted at 100° C. for 72 h in a Schlenk flask as indicated in Table 3. Aqueous HCl (2 N) was added to adjust the PH value to 1, followed by extraction with EtOAc (15 mL×3). The organic phase was washed with brine, dried over Na₂SO₄ and then evaporated in vacuo to give the recycled, pure 3H(Me)₂BA in 99% isolated yield.

### Instruments and Characterizations.

Nuclear Magnetic Resonance (NMR) analysis. NMR spectra were recorded on a Varian Inova or Bruker AV-III 400 MHz spectrometer (400 MHz, ¹H; 100 MHz, ¹³C) at 298 K. Chemical shifts (δ) are reported in ppm with the solvent resonance employed as the internal standard (chloroform-d1 at 7.26 ppm for ¹H-NMR and 77.0 ppm for ¹³C-NMR; hexafluoroisopropanol (HFIP)-d₂ at 4.41, 4.86 ppm for ¹H-NMR and 68.07, 120.66 ppm for ¹³C-NMR). Signals are reported as integration, multiplicity (s=singlet, d=doublet, t=triplet, q=quartet, m=multiplet or unresolved, br=broad signal), coupling constant(s) in Hz, assignment.

Absolute Molar Mass Measurements. Measurements by size exclusion chromatography (SEC). For P3H(Me)₂P and it-P3H(Me)₂B samples that require the use of HFIP to solubilize the polymer: weight average molar mass (Mw), number average molar mass (Mₙ), and molar mass dispersity (Ð=Mw/Mn) values were determined by SEC analysis on an Agilent 1260 Infinity II LC system coupled with a Wyatt Technology miniDAWN TREOS Multi-Angle Light scattering detector and a Wyatt Technology Optilab T-rEX differential refractometer. SEC analysis was conducted at 40° C. with a flow rate of 0.4 mL/min using three Agilent PL HFIP gel 250×4.6 mm columns and a matching guard column attached in series. 0.1p m filtered HPLC grade HFIP amended with 20 mM NaTFAc was used as the mobile phase. Samples were prepared at known concentrations to calculate dn/dc assuming 100% mass recovery and passed through 0.2 μm PTFE filters prior to sample injection. For P3H(R)₂B samples: measurements of polymer absolute M_{w}, Mₙ, and Ð values were performed by SEC on an Agilent HPLC system equipped with one guard column and three PLgel 5 m mixed-C gel permeation columns and coupled with a Wyatt DAWN HELEOS II multi-angle light scattering detector and a Wyatt Optilab TrEX dRI detector; the analysis was performed at 40° C. using CHCl₃ as the eluent at a flow rate of 1.0 mL/min, using Wyatt ASTRA 7.1.2 molar mass characterization software. Polymer solutions were prepared in CHCl₃ and injected into dRI detector by Harvard Apparatus pump 11 at a flow rate of 0.2 mL/min. A series of known concentrations were injected and the change in refractive index was measured to obtain a plot of change in refractive index versus change in concentration ranging from 0.5 to 10.0 mg/mL. The slope from a linear fitting of the data was the dn/dc of the P3H(Me)₂B polymer: dn/dc=0.0315±0.0005 mL/g.

Wide Angle X-Ray Scattering (WAXS). WAXS profiles of the as-synthesized samples were collected with Ni filtered Cu Kα radiation (λ=1.5418 Å) by using a Bruker D8 Discover DaVinci automatic diffractometer for measurements at room temperature, and an Empyrean diffractometer by Malvern Panalytical for measurements at high temperature, both operating in the reflection geometry with continuous scans of the 2θ angle and scanning rate of 0.02 degree/s. The values of the degree of crystallinity (xc) were determined from the WAXS profiles by the ratio between the crystalline diffraction area (Ac) and the area of the whole diffraction profiles (Aₜ=A_{c}+Aₐₘ), where Aam is the amorphous scattering area, xc=(Ac/At)ξ100. The area of the crystalline phase A_{c} was evaluated by subtracting a background baseline and the scattering halo of the amorphous phase (Aₐₘ) from the whole diffraction profile. The diffraction profile of the amorphous phase was obtained from the diffraction profile of the melt collected after heating the sample above its melting temperature.

The WAXS two-dimensional pattern of the fiber of at-P3H(Me)₂B has been recorded with Ni filtered Cu Kα radiation (λ=1.5418 Å) on a BAS-MS imaging plate (FUJIFILM) using a cylindrical camera and processed with a digital imaging reader Perkin Elmer Cyclone Plus (storage phosphor system).

Differential Scanning Calorimetry (DSC) and Thermal Gravimetric Analysis (TGA). Melting transition (Tₘ) and glass transition (T_{g}) temperatures were measured by DSC on an Auto Q20, TA Instrument. All Tₘ and T_{g} values were obtained from the second scan unless indicated otherwise. Both heating rate and cooling rate were 10° C./min unless indicated otherwise. Decomposition temperatures (T_{d}) and maximum rate decomposition temperatures (Tₘₐₓ) of the polymers were measured by TGA on a Q50 TGA Analyzer, TA Instrument. Polymer samples were heated from ambient temperature to 700° C. at a heating rate of 10° C./min. Values of Tₘₐₓ were obtained from derivative (wt %/° C.) vs. temperature (° C.) plots.

Mechanical Analysis. Tensile stress/strain testing was performed by an Instron 5966 universal testing system (10 kN load cell) on dog-bone-shaped test specimens (ASTM D638 standard; Type V) prepared via compression molding using a Carver Bench Top Laboratory Press (Model 4386) equipped with a two-column hydraulic unit (Carver, Model 3912, maximum force 24000 psi) unless indicated otherwise. Isolated polymer materials were loaded between non-stick Teflon paper sheets into a stainless-steel mold with inset dimensions 30×73.5×0.38 mm fabricated inhouse and compressed between two 6″×6″ steel electrically heated platens clamp force 5000 psi, at temperature 10° C. higher than each material's respective Tₘ. Specimens for analysis were generated via compression molding and cut using an ASTM D638-5-IMP cutting die (Qualitest) to standard dimensions. Mechanical behavior was averaged for all the specimens measured for each individual species investigated. Thickness (0.38±0.01 mm), width (3.18 mm), and grip length (26.4±0.2 mm) of the measured dog-bone specimens were measured for normalization of data by the Bluehill measurement software (Instron). Test specimens were affixed into the screw-tight grip frame. Tensile stress and strain were measured to the point of material break at a grip extension speed of 5.0 mm min⁻¹ at ambient conditions.

Rheological Analysis. Shear viscosity measurements were performed on a Discovery Series HR-2 hybrid rheometer (TA Instruments) under nitrogen gas flow (30 psi). Test specimens were loaded between two 8 mm steel electrically heated platen (EHP) loading discs. Test specimens were trimmed at predetermined temperatures above the Tm of respective polymers. The measurements were performed at gap lengths ˜800 m and an experimental axial force of ˜0.2 N. The shear viscosity (in melt) over time experiment was performed under flow mode with a shear rate \dot{r}=1 s⁻¹ and a duration time of 1800 s.

### Example 2. Lactone Monomer Synthesis

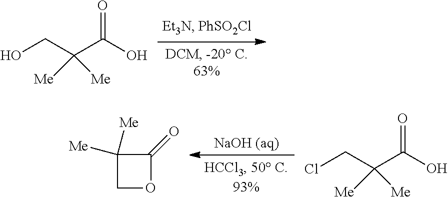 [SMILES: CC(C)(CO)C(=O)O ; CC1(C)COC1=O ; CC(C)(CCl)C(=O)O]

Synthesis of α,α-dimethyl-β-propiolactone [(Me)₂PL]: To a solution of commercially available 3-chloropivalic acid (15 g, 138.9 mmol) in chloroform (120 mL) was added sodium hydroxide aqueous solution (6.7 g NaOH, 2 N). The reaction mixture was heated to 50° C. After 4 h, the reaction mixture was cooled to room temperature, extracted with DCM (30 mL×3), and the organic phase was washed with brine, dried over Na₂SO₄, and concentrated in vacuo (35° C., 280 mbar). The resultant residue was purified by distillation (˜200 mTorr, 30-40° C., could be heated to 70-90° C. until the end) to obtain the monomer (Me)₂PL (9.3 g, 93%) as a colorless oil (isolation of the monomer must be done timely to prevent (Me)₂PL from being polymerized at room temperature). For this monomer synthesized: The isolated monomer was stored in a refrigerator of the glovebox (−20° C.) for further use.

In a different method, 3-hydroxy-2,2-dimethylpropionic acid [3H(Me)₂PA](3.54 g, 30 mmol) was dissolved in dry DCM (300 mL), and then triethylamine (20.8 mL, 150 mmol) was added at −20° C. After being stirred for 15 min, benzenesulfonyl chloride (7.7 mL, 60 mmol) was added dropwise at this temperature. The reaction was stirred at −20° C. for 16 h. Then the mixture was quenched with ice water, extracted with DCM (150 mL×3), and the combined organic layers were washed with saturated NaHCO₃, brine, dried over Na₂SO₄, and then evaporated in vacuo (35° C., vacuum higher than 280 mbar because of the product's low b.p.). The crude product was purified by short column chromatography on silica gel (pentane/acetone=30:1), concentrated in vacuo (35° C., vacuum higher than 280 mbar). After vacuum distillation (˜200 mTorr, 30-40° C.), the monomer (Me)₂PL (1.9 g, 63% yield) was obtained as a colorless oil. H NMR (400 MHz, CDCl₃): δ 4.06 (s, 2H), 1.39 (s, 6H); ¹³C NMR (101 MHz, CDCl₃): δ 175.3, 73.2, 53.2, 20.9.

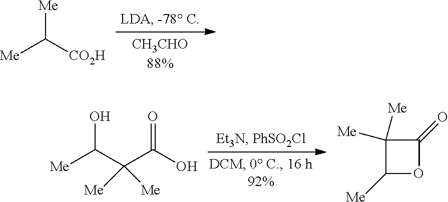 [SMILES: CC(C)C(=O)O ; CC(O)C(C)(C)C(=O)O ; CC1OC(=O)C1(C)C]

Synthesis of α,α-dimethyl-β-butyrolactone [(Me)₂BL]: To a solution of diisopropylamine (63 mL, 450 mmol) in THF (150 mL), ⁿBuLi (281 mL, 450 mmol, 1.6 M) was added dropwise at 0° C. After stirring for 1 h, the reaction mixture was cooled to −78° C. and isobutyric acid (13.9 mL, 150 mmol) in THF (60 mL) was added dropwise. After 0.5 h, the solution was heated at 55° C. for 4 h, followed by the addition of acetaldehyde (9.2 mL, 165 mmol) in THF (60 mL) at −78° C. Afterwards, the solution was allowed to gradually warm up to room temperature and stirred for 12 h. The mixture was quenched with H₂O and HCl aqueous (4 N) was added to adjust the PH value to 1. After extraction with EtOAc (150 mL×3), the organic phase was washed with brine, dried over Na₂SO₄, and then evaporated in vacuo and simple vacuum distillation (about 200 mTorr, 200-220° C.) to give the 3-hydroxy-2,2-dimethyl-β-butyric acid [3H(Me)₂BA](17.4 g, 88%). ¹H NMR (400 MHz, CDCl₃): δ 3.91 (q, J=6.4 Hz, 1H), 1.24 (s, 3H), 1.22-1.20 (m, 6H); ¹³C NMR (101 MHz, CDCl₃): δ 182.9, 72.4, 46.9, 22.4, 19.4, 17.5.

Distilled 3H(Me)₂BA (13.2 g, 100 mmol) was dissolved in dry DCM (900 mL), and then triethylamine (69.4 mL, 500 mmol) was added at 0° C. After stirring for 15 min, benzenesulfonyl chloride (25.5 mL, 200 mmol) was added dropwise. The reaction was stirred for 16 h at 0° C., and then the mixture was quenched with ice water and extracted with DCM (150 mL×3). The combined organic layers were washed with saturated NaHCO₃, brine, dried over Na₂SO₄, and then evaporated in vacuo (35° C., vacuum higher than 280 mbar because of the product's low b.p.). After a flash column chromatography on silica gel (Pentane/Acetone=30:1) and solvent removal in vacuo (35° C., vacuum higher than 280 mbar), the resultant residue was further purified by vacuum distillation (˜200 mTorr, 50-60° C.) to give the monomer (Me)₂BL (10.5 g, 92%) as a colorless oil. ¹H NMR (400 MHz, CDCl₃): δ 4.40 (q, J=6.4 Hz, 1H), 1.42 (d, J=6.4 Hz, 3H), 1.38 (s, 3H), 1.22 (s, 3H); ¹³C NMR (101 MHz, CDCl₃): δ 175.4, 79.4, 53.4, 22.2, 16.3, 15.7.

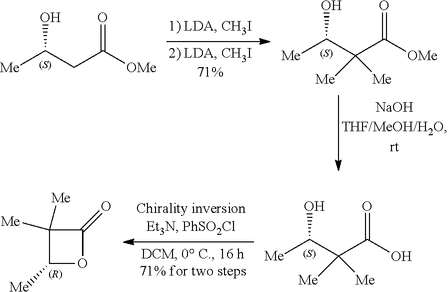

Synthesis of (R)-α,α-dimethyl-β-butyrolactone [(R)-(Me)₂BL]: To a solution of diisopropylamine (28.6 mL, 204.4 mmol) in THF (120 mL), ⁿBuLi (128 mL, 204.4 mmol, 1.6 M) was added dropwise at 0° C. After 1 h, the reaction mixture was cooled to −78° C. and methyl (2S,3S)-3-hydroxy-2-methylbutanoate (8.2 g, 61.9 mmol) in THF (20 mL) was added dropwise. After 0.5 h, the solution was warmed up and stirring at −20° C. for 1 h, followed by the addition of iodomethane (38.6 mL, 619 mmol) in THF (20 mL) at −78° C. Afterwards, the solution was stirring at −20° C. until all the substrate disappeared. After quenching with saturated NH₄Cl and extraction with ether (60 mL×3), the organic phase was washed with brine, dried over Na₂SO₄, and then evaporated in vacuo, followed by flash column chromatography (to remove any monosubstituted product) to give methyl (S)-3-hydroxy-2,2-dimethylbutanoate (6.4 g, 71%). ¹H NMR (400 MHz, CDCl₃): δ 3.84 (q, J=6.8 Hz, 1H), 3.68 (s, 3H), 2.70 (s, 1H), 1.15-1.14 (m, 6H), 1.11 (d, J=6.4 Hz, 3H); ¹³C NMR (101 MHz, CDCl₃): δ 178.2, 72.4, 51.8, 47.1, 22.2, 19.7, 17.6.

To a solution of methyl (S)-3-hydroxy-2,2-dimethylbutanoate (3.9 g, 26.7 mmol) in THF/MeOH (30/30 mL) was added sodium hydroxide solution (5.3 g NaOH, 134 mmol) in THF/MeOH/H₂O (40/40/30 mL). The mixture was stirred for 10 h at 30° C. and then was evaporated in vacuo. HCl aqueous (4 N) was added to adjust the PH value to 1, followed by extraction with EtOAc (60 mL×3). The organic phase was washed with brine, dried over Na₂SO₄, and then evaporated in vacuo, followed by simple vacuum distillation (about 200 mTorr, 200-220° C.) to give the (S)-3-hydroxy-2,2-dimethyl-β-butyric acid [(S)-3H(Me)₂BA].

(S)-3H(Me)₂BA was dissolved in dry DCM (150 mL), and then triethylamine (18.5 mL, 133.5 mmol) was added at 0° C. After stirring for 15 min, benzenesulfonyl chloride (6.8 mL, 53.4 mmol) was added dropwise. After 16 h at 0° C., the mixture was quenched with ice water and extracted with DCM (80 mL×3). The combined organic layers were washed with saturated NaHCO₃, brine, dried over Na₂SO₄, and then evaporated in vacuo (35° C., no less than 280 mbar because of the product's low b.p.). After flash column chromatography on silica gel (pentane/acetone=30:1) and solvent removal in vacuo (35° C., vacuum higher than 280 mbar), the resultant residue was purified by vacuum distillation (˜200 mTorr, 50-60° C.) to give the monomer (R)-(Me)₂BL (2.2 g, 71% for two steps) as a colorless oil. [α]_{D}^{26.2}=−38.1 (c=0.35, CHCl₃); ¹H NMR (400 MHz, CDCl₃): δ 4.42 (q, J=6.4 Hz, 1H), 1.44 (d, J=6.4 Hz, 3H), 1.40 (s, 3H), 1.24 (s, 3H).

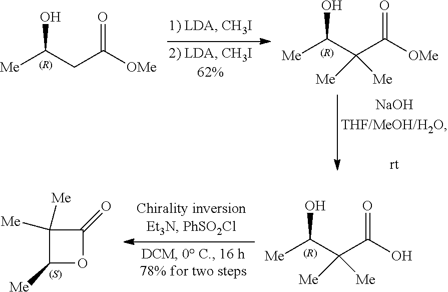

Synthesis of (S)-α,α-dimethyl-β-butyrolactone [(S)-(Me)₂BL]: To a solution of diisopropylamine (35 mL, 250 mmol) in THF (200 mL), ⁿBuLi (156 mL, 250 mmol, 1.6 M) was added dropwise at 0° C. After 1 h, the reaction mixture was cooled to −78° C. (dry ice/acetone) and methyl (2R,3R)-3-hydroxy-2-methylbutanoate (10 g, 75.8 mmol) in THF (20 mL) was added dropwise. After 0.5 h, the solution was warmed up and stirred at −20° C. for 1 h, followed by the addition of iodomethane (47 mL, 758 mmol) in THF (30 mL) at −78° C. Afterwards, the solution was stirring at −20° C. until all the substrate disappeared. After quenching with saturated NH₄Cl and extraction with ether (60 mL×3), the organic phase was washed with brine, dried over Na₂SO₄, and then evaporated in vacuo, followed by flash column chromatography (to remove any monosubstituted product) to give methyl (R)-3-hydroxy-2,2-dimethylbutanoate (6.2 g, 62%).

To a solution of methyl (R)-3-hydroxy-2,2-dimethylbutanoate (5.8 g, 40 mmol) in THF/MeOH (30/30 mL) was added sodium hydroxide solution (8 g NaOH, 200 mmol) in THF/MeOH/H₂O (40/40/30 mL). The mixture was stirred for 10 h at 30° C. and then was evaporated in vacuo. HCl aqueous (4 N) was added to adjust the PH value to 1, followed by extraction with EtOAc (60 mL×3). The organic phase was washed with brine, dried over Na₂SO₄, and then evaporated in vacuo, followed by simple vacuum distillation (about 200 mTorr, 200-220° C.) to give the crude (R)-3-hydroxy-2,2-dimethyl-β-butyric acid [(R)-3H(Me)₂BA].

(R)-3H(Me)₂BA was dissolved in dry DCM (200 mL), and then triethylamine (27.7 mL, 200 mmol) was added at 0° C. After stirring for 15 min, benzenesulfonyl chloride (10.2 mL, 80 mmol) was added dropwise. The reaction was stirred for 16 h at 0° C., and then quenched with ice water, followed by extraction with DCM (80 mL×3). The combined organic layers were washed with saturated NaHCO₃, brine, dried over Na₂SO₄, and then evaporated in vacuo (35° C., vacuum higher than 280 mbar because of the product's low b.p.). After flash column chromatography on silica gel (pentane/acetone=30:1) and solvent removal in vacuo (35° C., vacuum higher than 280 mbar), the resultant residue was further purified by vacuum distillation (about 200 mTorr, 50-60° C.) to give the monomer (S)-(Me)₂BL (3.6 g, 78% for two steps) as a colorless oil. [α]_{D}^{26.2}=+40.9 (c=0.40, CHCl₃); ¹H NMR (400 MHz, CDCl₃): δ 4.42 (q, J=6.4 Hz, 1H), 1.44 (d, J=6.4 Hz, 3H), 1.41 (s, 3H), 1.24 (s, 3H).

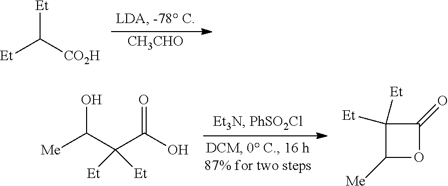

Synthesis of α,α-diethyl-β-butyrolactone [(Et)₂BL]: To a solution of diisopropylamine (84 mL, 600 mmol) in THF (300 mL), ⁿBuLi (375 mL, 600 mmol, 1.6 M) was added dropwise at 0° C. After 1 h, the reaction mixture was cooled to −78° C. and 2-ethylbutyric acid (25.2 mL, 200 mmol) in THF (100 mL) was added dropwise. After 0.5 h, the solution was warmed up to 55° C. and stirred at this temperature for 4 h, followed by the addition of acetaldehyde (12.3 mL, 220 mmol) in THF (100 mL) at −78° C. Afterwards the mixture was stirred for 12 h (gradually returned to room temperature), and then was quenched with H₂O. HCl aqueous (4 N) was added to adjust the PH value to 1, followed by extraction with EtOAc (150 mL×3). The organic phase was washed with brine, dried over Na₂SO₄, and then evaporated in vacuo to give the crude 3-hydroxy-2,2-diethyl-β-butyric acid [3H(Et)₂BA], which was directly used in the next step without further purification.

Crude 3H(Et)₂BA was dissolved in dry DCM (1.2 L), and then triethylamine (139 mL, 1000 mmol) was added at 0° C. After stirring for 15 min, benzenesulfonyl chloride (51 mL, 400 mmol) was added dropwise. After stirring for 16 h at 0° C., the mixture was quenched with ice water and extracted with DCM (150 mL×3). The combined organic layers were washed with saturated NaHCO₃, brine, dried over Na₂SO₄, and then evaporated in vacuo. After flash column chromatography on silica gel (pentane/acetone=30:1) and solvent removal in vacuo, the resultant residue was further purified by vacuum distillation (˜200 mTorr, 65-80° C.) to give the monomer (Et)₂BL (24.7 g, 87% for two steps) as a colorless oil. ¹H NMR (400 MHz, CDCl₃): δ 4.45 (q, J=6.8 Hz, 1H), 1.87-1.73 (m, 3H), 1.69-1.60 (m, 1H), 1.45 (d, J=6.4 Hz, 3H), 1.01-0.95 (m, 6H); ¹³C NMR (101 MHz, CDCl₃): δ 174.3, 77.1, 60.9, 24.1, 20.0, 15.4, 7.9 (2), 7.8 (8).

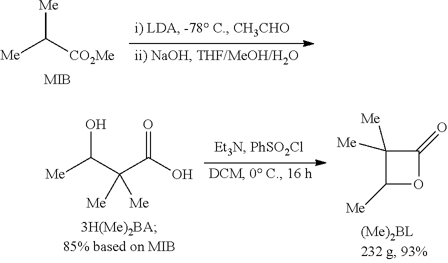 [SMILES: COC(=O)C(C)C ; CC(O)C(C)(C)C(=O)O ; CC1OC(=O)C1(C)C]

Large-scale synthesis (>200 g) of (Me)₂BL. To the solution of diisopropylamine (515.2 g, 717.5 mL, 5.0 mol,) in THF (500 mL), ⁿBuLi (3.18 L, 5.0 mol, 1.6 M) was added dropwise at 0° C. by using cannula (over the period of 6 hours) and the mixture was stirred at this temperature for another 1 h. Then reaction mixture was cooled at −78° C. for 15 minutes and methyl isobutyrate (MIB, 400 g, 448.9 mL, 3.9 mol) in THF (200 mL) was added dropwise at −78° C., after stirring at the same temperature for 1 h, acetaldehyde (189.7 g, 243.3 mL, 4.3 mmol) in THF (150 mL) was added and reaction was stirred for 4 hours (monitored by ¹H NMR) at −78° C. The reaction mixture was quenched with aqueous saturated NH₄Cl solution, extracted with diethyl ether (500 mL×3), the organic phase was washed with brine and dried over Na₂SO₄, and then evaporated on rotary evaporator at 28-30° C. (low boiling) to afford the crude product (470 g) which was used directly for hydrolysis step. The methyl-3-hydroxy-2,2-dimethylbutanoate was dissolved in THF/MeOH (100/100 mL). Then sodium hydroxide solution (385.7 g of NaOH, 9.6 mol) in THF/MeOH/H2O (200/200/800 mL) was added dropwise to reaction mixture at 0° C. and stirred for 4 h at 30° C. After completion of the reaction solvents (methanol and THF) were evaporated in vacuum and aqueous HCl (4 N) was added to adjust the PH value to 1. The reaction mixture was extracted with EtOAc (500 mL×3), the organic phase was washed with brine, dried over Na₂SO₄, and evaporated on rotary evaporator, followed by vacuum distillation (about 200 mTorr, 180-200° C.) to afford a yellow viscous liquid of 3-hydroxy-2,2-dimethyl-β-butyric acid [3H(Me)₂BA](362 g, 85%). ¹H NMR (400 MHz, CDCl₃): δ 3.91 (q, J=6.4 Hz, 1H), 1.24 (s, 3H), 1.22-1.20 (m, 6H); ¹³C NMR (101 MHz, CDCl₃): δ 182.9, 72.4, 46.9, 22.4, 19.4, 17.5.

The distilled 3H(Me)₂BA (2.2 mol, 320.2 g) was dissolved in dry DCM (4 L) using overhead stirrer (500 rpm) followed by triethylamine (1.5 L, 10.9 mol) was added at 0° C. After stirring for 15 min, benzenesulfonyl chloride (561.5 mL, 4.3 mol) was added dropwise. The reaction was stirred for 16 h at 0° C., and then the mixture was quenched with ice water and extracted with DCM (300 mL×3). The combined organic layers were washed with saturated NaHCO₃ aqueous, brine, dried over Na₂SO₄, and solvent was evaporated on rotary evaporator at 35° C. To remove acid impurities a rapid flash column chromatography was performed on silica gel (pentane/acetone=30:1) to afford the resulting liquid residue which was further purified by vacuum distillation (˜200 mTorr, 50-60° C.) to furnish the monomer (Me)₂BL (232 g, 93%) as a colorless oil. ¹H NMR (400 MHz, CDCl₃): δ 4.40 (q, J=6.4 Hz, 1H), 1.42 (d, J=6.4 Hz, 3H), 1.38 (s, 3H), 1.22 (s, 3H); ¹³C NMR (101 MHz, CDCl₃): (175.4, 79.4, 53.4, 22.2, 16.3, 15.7.

### Example 3. Synthesis and Circular Recycling of Polymers and Copolymers

Synthesis of poly(2,2-dimethyl-3-hydroxypropionate), P(2,2-Me₂-3HP), from ROP of pivalolactone. Polymerization of pivalolactone or α,α-dimethyl-β-propiolactone (prepared by either 3-hydroxypivalic acid+PhSO₂Cl+Et₃N or 3-chloropivalic acid+NaOH) was performed in a 10 mL Schlenk flask with a monomer/catalyst (TBD)/BnOH (benzyl alcohol) ratio of 800/1/1 at 70° C. The catalyst (TBD, 0.0025 mmol) and initiator (BnOH, 0.0025 mmol) were mixed and upon stirring for 10 min in an inert gas (N₂ or Ar) supplied glovebox. To this flask pivalolactone (2.0 mmol) was quickly added via a syringe, and the mixture was stirred at 70° C. After 15 min, the reaction was quenched by addition of 0.2 mL benzoic acid in chloroform (5 mg/ml), and the quenched polymer was dissolved in 2 mL of (CF₃)₂CHOH (1,1,1,3,3,3-hexafluoro-2-propanol). The solution was precipitated into 75 mL of cold methanol, filtered, washed with methanol to remove any unreacted monomer and catalyst residue, and dried in a vacuum oven at 60° C. to a constant weight. The resulting polyester as crystalline hard white solid, which is insoluble in common organic solvents but (CF₃)₂CHOH, was analyzed by DSC (differential scanning calorimetry) to give a high Tₘ of 232° C., ΔHₘ=138 J/g, and a T_{g} of 91° C., and by TGA (thermogravimetric analysis) to give a high T_{d} of 321° C. (at 5% weight loss). ¹H NMR ((CF₃)₂CDOD, 25° C.): δ 4.33 (s, 2H), 1.43 (s, 6H). ¹³C NMR ((CF₃)₂CDOD, 25° C.): δ 177.7, 70.8, 43.0, 20.8. For comparison, NMR data of the lactone monomer are also listed here: ¹H NMR (400 MHz, CDCl₃): δ 4.09 (s, 2H), 1.43 (s, 6H).

Synthesis of poly(2,2-dimethyl-3-hydroxypropionate), P(2,2-Me₂-3HP), from polycondensation of 3-hydroxypivalic acid. A flask was loaded with a stir bar, 5.9 g of 3-hydroxypivalic acid, 170 mg of Ti(OⁿBu)₄ (1 mol %) and connected to the distillation unit. The flask was first heated at 170° C. for 4 h, then increased the temperature to 230° C. for 4 h, and finally reacted for another 4 h at this temperature but under vacuum. After the reaction was cooled to room temperature, the product was dissolved in 30 mL of (CF₃)₂CHOH. The solution was precipitated into 500 mL of cold methanol, filtered and dried in a vacuum oven at 60° C. to a constant weight. The resulting hard pale-yellow solid was analyzed by DSC to give a high Tₘ of 218° C., ΔHₘ=124 J/g, and a T_{g} of 96° C.

Chemical recycling of P(2,2-Me₂-3HP). This polymer can be recycled back to either the pivalolactone monomer or 3-hydroxypivalic acid, depending on the catalyst and conditions employed. A flask containing 3.4 g of the purified P(2,2-Me₂-3HP) and 462 mg of ZnCl₂ (10 mol %) was heated at 250° C. in a vacuum distillation setup. The receiving flask was cooled in a −78° C. bath to collect the distilled monomer. After reacting for 12 h, a colorless liquid was collected and analyzed by ¹H NMR analysis to be the pure pivalolactone. Inorganic base Mg(OH)₂ also could be used for this depolymerization to the lactone.

A flask containing 100 mg of the purified P(2,2-Me₂-3HP) and 2 mL of NaOH (4 N) aq. in THF/MeOH (30/0.5 mL) was heated at 80° C. for 24 h. Then, HCl aqueous (2 N) was added to adjust the PH value to 1.0. The mixture was extracted with EtOAc (200 mL×3), and the organic extracts were washed with brine and then dried over anhydrous Na₂SO₄. After filtering off the drying agent, the solution was evaporated in vacuo to obtain the product, which was shown by ¹H NMR analysis to be quantitatively recovered pure 3-hydroxypivalic acid, without column chromatography purification.

Synthesis of poly(2,2-dimethyl-3-hydroxybutyrate), P(2,2-Me₂-3HB). Polymerizations of rac-3,3,4-trimethyl-2-oxetanone or rac-α,α-dimethyl-β-butyrolactone [prepared from (a) methyl isobutyrate, lithium diisopropylamide, acetaldehyde, (b) NaOH, and (c) PhSO₂Cl, Et₃N] were performed in 10 mL Schlenk flasks with an organic base and BnOH. The base and BnOH were mixed upon stirring for 10 min in a glovebox, in neat or in THF. To this flask the monomer was quickly added via a syringe, and the mixture was stirred at 70° C. After a predetermined time, the reaction was quenched by addition of 0.2 mL benzoic acid in chloroform (5 mg/ml), and the quenched mixture was precipitated into 75 mL of cold methanol, filtered, washed with methanol to remove any unreacted monomer and catalyst residue, and dried in a vacuum oven at 60° C. to a constant weight.

In a specific run with monomer/^{t}Bu-P₄/BnOH=400/1/1 in bulk (neat, no solvent), the reaction in 30 min converted 99% of the monomer into polymer with Mₙ=21.9 kg/mol and Ð=1.11 measured by GPC (gel-permeation chromatography). In another run with monomer/^{t}Bu-P₄/BnOH=800/0.5/1 in THF (2.0 M), the reaction achieved 99% of the monomer to give a high molecular weight polymer with Mₙ=93.5 kg/mol and Ð=1.08. This polyester is a semi-crystalline material with two Tₘ endotherms of 168 and 172° C. and a T_{g} of 30° C., and a T_{d} of 315° C. (at 5% weight loss). ¹H NMR (CDCl₃, 25° C.): δ 5.15-5.07 (m, 1H), 1.22-1.06 (m, 9H), ¹³C NMR (CDCl₃, 25° C.): δ 174.4 (1), 174.3 (7), 174.3 (6), 174.3 (1), 174.2 (8), 174.2 (7), 174.2 (5), 174.2 (2), 74.4, 74.3 (4), 74.3 (2), 46.4 (8), 46.4 (6), 46.4 (3), 46.4 (0), 22.1 (3), 22.0 (9), 22.0 (4), 21.9 (5), 21.9 (0), 21.8 (5), 21.8 (3), 21.0 (8), 21.0 (5), 20.9 (9), 20.7 (9), 20.7 (5), 20.7 (1), 20.6 (9), 20.0 (8), 20.0 (5), 19.9 (3), 19.9 (1), 15.1, 14.9. For comparison, NMR data of the lactone monomer is listed here: ¹H NMR (400 MHz, CDCl₃): δ 4.42 (q, J=6.4 Hz, 1H), 1.44 (d, J=6.4 Hz, 3H), 1.40 (s, 3H), 1.24 (s, 3H).

This polymer was recycled back to the lactone monomer. A flask containing 570 mg of the purified P(2,2-Me₂-3HB) and 29 mg of Mg(OH)₂ (10 mol %) was heated at 250° C. in a vacuum distillation setup. The receiving flask is cooled in a −78° C. bath to collect the pure monomer rac-α,α-dimethyl-β-butyrolactone as shown by ¹H NMR analysis. When ZnCl₂ was used as the catalyst, 2,2-dimethyl-3-butenoic acid byproduct (42%) was obtained.

Synthesis of poly(2,2-dimethyl-3-thiopropionate), P(2,2-Me₂-3TP), from ROP of 2,2-dimethyl-3-propiothiolactone. The ROP was performed in 5 mL glass reactors inside a glovebox at ambient temperature. The DBU/BnOH mixture (0.0025/0.0025 mmol) was stirred for 10 min in 0.2 mL of dichoromethane. To this mixture the monomer (400 equiv, 5.0 M) was quickly added via a pipette, and the mixture was stirred for 12 h to achieve >99% conversion. The polymerization was quenched by addition of 0.2 mL benzoic acid in chloroform (5 mg/ml), and the quenched solution was precipitated into 75 mL of cold methanol, filtered, washed with methanol to remove any unreacted monomer and catalyst residue, and dried in a vacuum oven at 60° C. to a constant weight. The resulting white elastomeric polymer showed Mₙ=46.1 kg/mol and Ð=1.44 by GPC, a T_{g} of −1.1° C. by DSC, and a T_{d} of 269° C. by TGA. H NMR (CDCl₃, 25° C.): δ 3.18 (s, 2H), 1.26 (s, 6H). ¹³C NMR (CDCl₃, 25° C.): δ 203.9, 50.6, 37.3, 24.7. For comparison, NMR data of the thiolactone monomer are also listed here: ¹H NMR (400 MHz, CDCl₃): δ 2.82 (s, 2H), 1.38 (s, 6H). This polymer was depolymerized back to monomer in the presence of DBU (10 mol %) at 120° C.

Synthesis of poly(2,2-dimethyl-5-hydroxyvalerate), P(2,2-Me₂-5HV), from ROP of α,α-dimethyl-δ-valerolactone. Polymerization was performed in 30 mL oven-dried glass reactors inside an inert (N₂ or Ar supplied) glovebox under ambient conditions (˜23° C.). The lactone monomer (200 equiv. vs. catalyst) was first dissolved in toluene, and the polymerization was started by rapid addition of the La[N(SiMe₃)₂]₃/3BnOH mixture in toluene to the above solution under vigorous stirring. The starting monomer concentration was 1.0 M. After 5 min, the polymerization was immediately quenched by addition of 0.5 mL of benzoic acid/CDCl₃ (10 mg/mL) and were later analyzed by ¹H NMR to obtain a percent monomer conversion of 79%. The quenched mixture was then precipitated into 50 mL of cold methanol while stirring, filtered, washed with cold methanol to remove any unreacted monomer, and dried in a vacuum oven at room temperature overnight to a constant weight. The polyester was analyzed by GPC to give Mₙ=11.8 kg/mol and Ð=1.12, by DSC to give a Tₘ of 75° C. and a T_{g} of −40° C., and by TGA to give a T_{d} of 264° C. (at 5% weight loss). Changing the catalyst to La(OBn)₃ and the monomer/catalyst ratio to 3000/1 yielded a high molecular weight polyester with Mₙ=104 kg/mol and D=1.12.

Synthesis of poly(2,2-diethyl-5-hydroxyvalerate), P(2,2-Et₂-5HV), from ROP of α,α-diethyl-δ-valerolactone. Polymerization was performed in 30 mL oven-dried glass reactors inside an inert (N₂ or Ar supplied) glovebox under ambient conditions (˜23° C.). The lactone monomer (200 equiv. vs. catalyst) was first dissolved in toluene, and the polymerization was started by rapid addition of the La[N(SiMe₃)₂]₃/3BnOH mixture in toluene to the above solution under vigorous stirring. The starting monomer concentration was 2.0 M. After 30 min, the polymerization was immediately quenched by addition of 0.5 mL of benzoic acid/CDCl₃ (10 mg/mL) and were later analyzed by ¹H NMR to obtain the percent monomer conversion data. The quenched mixture was then precipitated into 50 mL of cold methanol while stirring, filtered, washed with cold methanol to remove any unreacted monomer, and dried in a vacuum oven at room temperature overnight to a constant weight. The polyester was analyzed by GPC to give Mₙ=11.2 kg/mol and Ð=1.12 and by DSC to give a Tₘ of 138° C. Changing the catalyst to La(OBn)₃ and the monomer/catalyst ratio to 3000/1 (1.0 M monomer concentration) yielded a high molecular weight polyester with Mₙ=195 kg/mol, Ð=1.92, and Tₘ=140° C.

Synthesis of poly[2,2-di(n-propyl)-5-hydroxyvalerate), P(2,2-ⁿPr₂-5HV), from ROP of α,α-di(ⁿ-propyl)-δ-valerolactone. Using the same polymerization procedure for the ROP of α,α-diethyl-6-valerolactone with a monomer/La[N(SiMe₃)₂]₃/BnOH ratio of 200/1/3 produced P(2,2-ⁿPr₂-5HV) with Mₙ=15.5 kg/mol, Ð=1.11, Tₘ=123° C., T_{g}=−18° C., and T_{d}=281° C. Likewise, changing the catalyst to La(OBn)₃ and using a higher monomer/catalyst ratio let to a high molecular weight polyester with Mₙ=121 kg/mol, Ð=1.05, Tₘ=123° C., T_{g}=−18° C., and T_{d}=347° C. Mechanical testing showed that this polyester exhibits a high tensile modulus of E=568±19 MPa and it shows a ductile behavior with an appreciable elongation at break of ε_{B}=209±13%; it is also a strong material with a tensile strength of σ_{B}=44.0±2.6 MPa and displays an impressive strain hardening phenomenon after the yield point (σ_{y}=20.7±0.3 MPa), thereby characterized as a tough material.

Depolymerization of P(2,2-ⁿPr₂-5HV) to α,α-di(n-propyl)-δ-valerolactone. To a 10 mL round-bottom flask, P(2,2-ⁿPr₂-5HV) (1.00 g) and catalyst ZnCl₂ (2 mol %, 14.8 mg) were added. The mixture was heated to 150° C. under vacuum in a distillation setup, and the receiving flask was cooled with liquid nitrogen/acetone bath to trap the condensed product. After 1 h, the distillation had finished, and 0.98 g of pure monomer α,α-di(n-propyl)-δ-valerolactone was collected; yield, 98%.

Other P(2,2-R₂-5HV) materials were depolymerized in similar fashion to recover the corresponding monomers in pure state and essentially quantitative yield.

### Example 4. Additional Methods and Procedures

Both the α,α-dimethylated poly(3-hydroxy-2,2-dimethylpropionate) [P3H(Me)₂P] and P3H(Me)₂B can now be chemically recycled back to their starting monomer, α,α-dimethyl-β-propiolactone [(Me)₂PL] and α,α-dimethyl-β-butyrolactone [(Me)₂BL], respectively, achieving the first reported examples of PHAs with closed-loop chemical recyclability.

The α,α-dialkylated PHAs can be synthesized through either the step-growth polycondensation reaction (SGP) of hydroxyacids (HAs), 3-hydroxy-2,2-dimethylpropionic acid [3H(Me)₂PA] and 3-hydroxy-2,2-dimethylbutyric acid [3H(Me)₂BA], or the chain-growth ROP of lactones, (Me)₂PL and (Me)₂BL. 3H(Me)₂PA is commercially available, while the lactone (Me)₂PL was prepared via one-step lactonization of the HA. Other dialkyl-substituted lactones (R)₂PL (R=Et, ⁿPr, ⁿBu) (Et)₂BL were synthesized using the lactonization method. Importantly, the HA and lactone monomers can be prepared or recovered in good to quantitative yields from depolymerizing the PHAs.

At the outset, the ROP of (Me)₂PL was explored by employing different organic base catalysts and reaction conditions (Table 1). Given the insolubility of the semicrystalline P3H(Me)₂P in common organic solvents, the ROP was optimized in neat and at 70° C. with superbase ^{t}Bu-P₄ {1-tert-butyl-4,4,4-tris(dimethylamino)-2,2-bis[tris(dimethylamino)phosphoranylidenamino]2λ⁵,4λ⁵-catenadi(phosphazene)}. For example, with a [(Me)₂PL]/[^{t}Bu-P₄]/[BnOH] ratio of 6400/1/1, the solvent-free ROP at 70° C. achieved 99% conversion in 1 h, producing P3H(Me)₂P with Mₙ 162 kDa and Ð=1.43.

A synergistic benefit of using α,α-dialkyl substitution to suppress the cis-elimination for enhancing the PHA thermal stability is enabling the simple SGP route to PHAs. Thus, P3H(Me)₂P can also be efficiently produced by SGP of 3H(Me)₂PA or its methyl ester, catalyzed by Ti(OⁿBu)₄ or B(C₆F₅)₃, due to the absence of α-hydrogens and thus the elimination of crotonate end group formation through transesterification and elimination/termination side reactions, which is a significant issue hampering the synthesis of PHAs via SGP. Indeed, ¹H NMR spectrum of P3H(Me)₂P showed no alkene end groups, further confirming the effectiveness of the design of using α,α-dialkyl substitution to suppress the cis-elimination process. Worth noting here is the thermal properties of P3H(Me)₂P produced by SGP and ROP routes are similar.

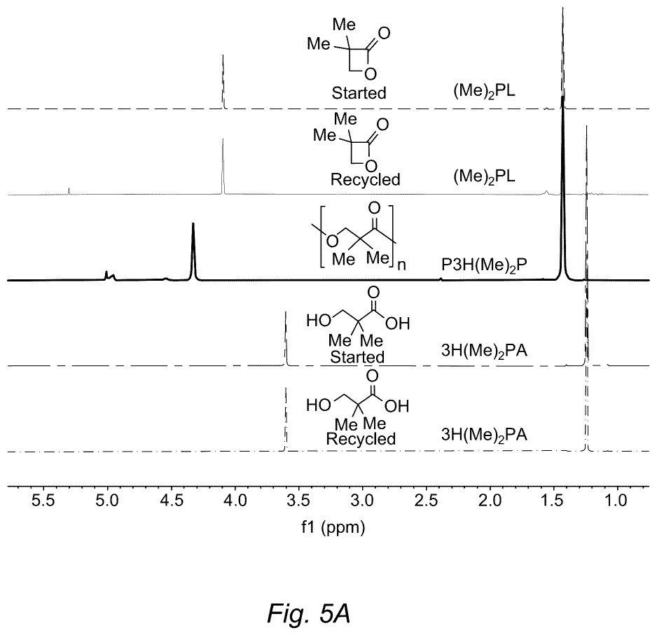

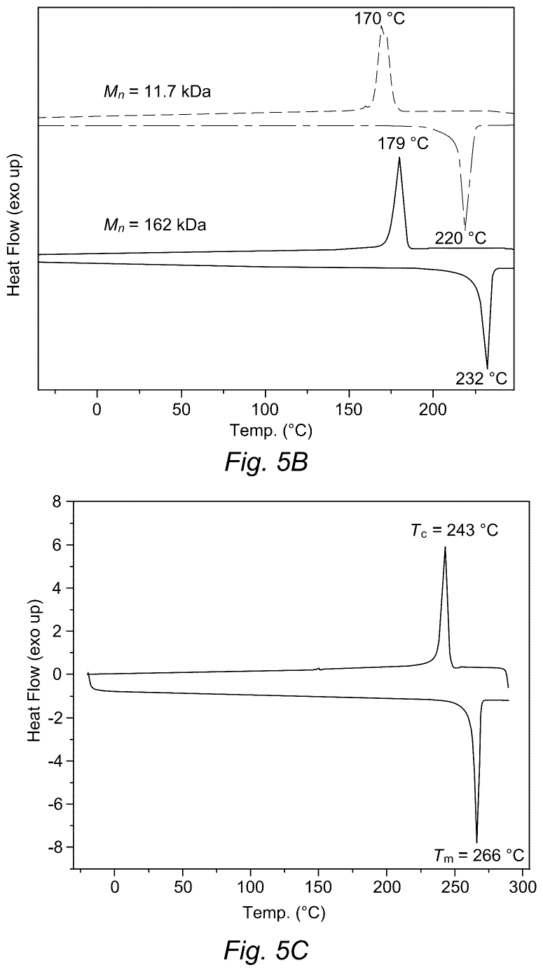

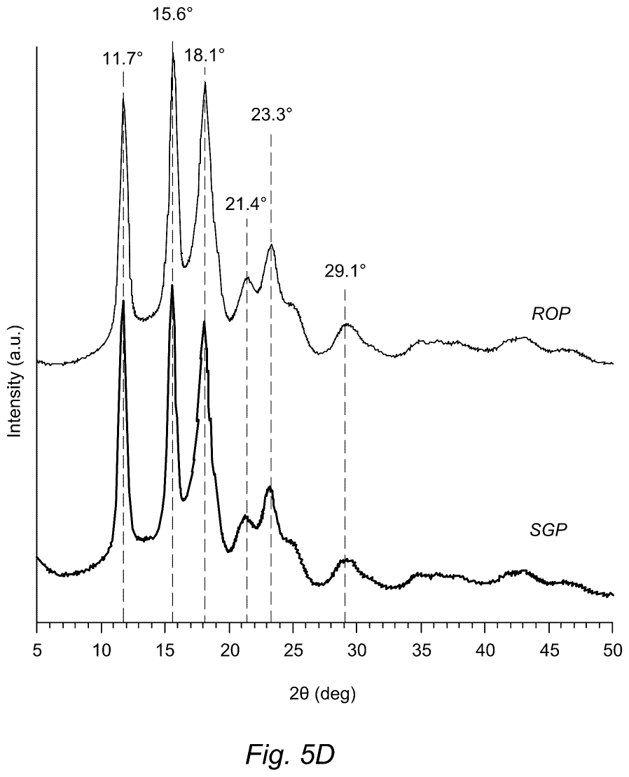

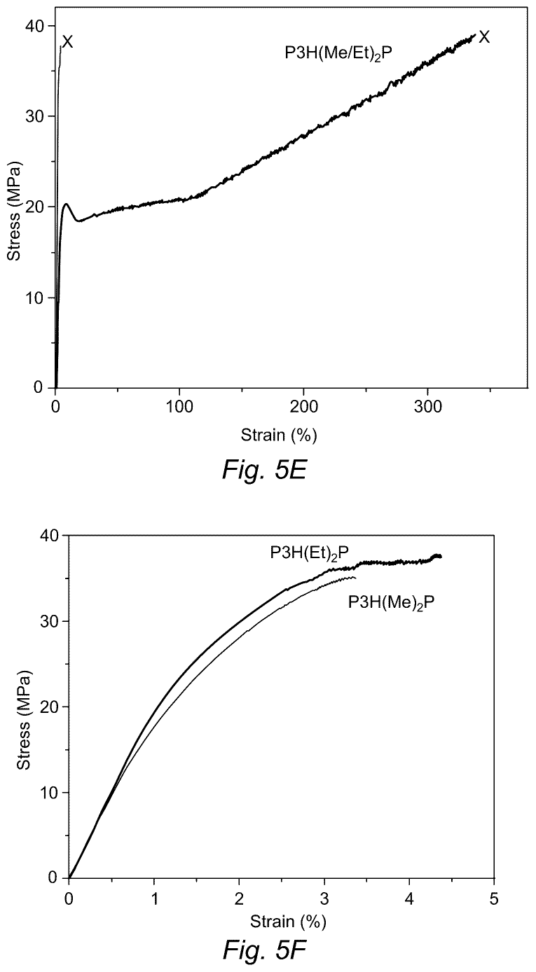

A P3H(Me)₂P sample prepared via SGP of 3H(Me)₂PA-methyl ester was depolymerized at 230° C. under vacuum, affording the recycled, pure (Me)₂PL in 76% isolated yield (FIG. 5A). These results demonstrate that the SGP can be used to obtain oligomers or polymers with low to medium molecular weights, which are effectively depolymerized to form the lactones for the rapid ROP to high-molecular-weight PHAs. The second pathway to establish the closed-loop chemical recycling is through hydrolytic depolymerization of PHAs to HAs. For example, hydrolysis of a ROP-produced P3H(Me)₂P sample (Mₙ=20.7 kDa) with aq. NaOH in THF/MeOH at 80° C. for 24 h afforded pure 3H(Me)₂PA in 99% isolated yield without chromatography purification (FIG. 5A). The same condition is also efficient for depolymerization of the SGP-derived samples to pure 3H(Me)₂PA in 99% yield. Noteworthy here is that the P3H(Me)₂P recycling via the HA-PHA loop is particularly valuable due to the quantitative hydrolysis yield and the similar thermal properties between the SGP- and ROP-produced P3H(Me)₂P.

Installation of the α,α-dimethyl groups to poly(3-hydroxypropionate) (P3HP) increased its Tₘ from 77° C. to 232° C. (ΔH_{f}=126 J/g) for the resulting P3H(Me)₂P (Mₙ=162 kDa) from the ROP (FIG. 5B). Interestingly, the Tₘ of the P3H(Me)₂P produced by SGP with a much lower molecular weight (Mₙ=11.7 kDa) is similarly high, 220° C., also accompanied by a high ΔH_{f} of 112 J/g for a high degree of crystallinity (FIG. 5B). Hence, PCR offers an alternative, convenient pathway to yield P3H(Me)₂P with the comparable thermal property.

There is an increase in Tₘ for P3H(R)₂P with increasing the chain length of the dialkyl groups form methyl to ethyl and eventually to n-propyl, leading to the highest Tₘ of 266° C. (FIG. 5C). When the M. of P3H(Me)₂P was increased from 20.7 to 162 kDa, the T_{d} was enhanced by 51° C. from 322 to 373° C. but the Tₘ was changed only slightly (by 8° C.).

The ROP-produced P3H(Me)₂P (Mₙ=162 kDa) also shows three major WAXS diffractions centered at 2θ≈11.7°, 15.6° and 18.1°, and other diffractions of lower intensities at higher 20 values. The same analysis procedure yielded x_{c}=76% for P3H(Me)₂P. Interestingly, essentially identical WAXS profiles were observed for the P3H(Me)₂P samples produced from SGP and ROP (FIG. 5D). Remarkably, the T_{d} of P3H(Me)₂P (Mₙ=162 kDa) reached to 373° C. with a Tₘₐₓ of 435° C.

Owing to their fast crystallization and high degree of crystallinity, the α,α-dialkylated derivatives of P3HP, including P3H(Me)₂P (Mₙ=162 kDa) and P3H(Et)₂P (Mₙ=80 kDa), are highly brittle, with a low ε_{b} value (FIG. 5E). However, this mechanical brittleness can be overcome by forming a Me/Et random copolymer (Mₙ=79 kDa), P3H(Me/Et)₂P. This semicrystalline copolymer is ductile and tough with ultimate tensile strength (σ)=38±2.0 MPa and ε_{b}=335±8.0% (FIG. 5E), which is commensurable with it-PP and outperforms high-density PE (HDPE). The shear viscosities for P3H(Me)₂P remained constant without obvious decrease over a timeframe of 30 mins at temperatures up to 240° C., which is well above their corresponding melting temperature.

For P3H(R)₂P, R=Me, Et, ⁿPr, ⁿBu. ROP reactions were performed in 10 mL Schlenk flasks or 5.5 mL glass reactors inside an inert glovebox at ambient temperature (˜23° C.). A mixture of base catalyst and alcohol initiator indicated in the polymerization tables was stirred at ambient temperature for 10 min, and then a predetermined amount of lactone monomer (R)₂PL was added. The sealed reactors were taken out from the glove box and stirred at 70° C. After a desired time period, the mixture turned into solid, and a sample was taken from the reaction mixture and prepared for ¹H NMR analysis to obtain the percent monomer conversion data. Then the polymerization was quenched by addition of benzoic acid in CHCl₃ (5 mg/mL) and dissolved with 1,1,1,3,3,3-hexafluoro-2-propanol (HFIP), followed by precipitation in methanol for 2-3 times. After filtration, the white polymer solid was dried in vacuo at 60° C. to a constant weight.

Polycondensation reactions were conducted in 100 mL three-neck round-bottom flasks equipped with a magnetic stirrer. HA monomer 3H(Me)₂PA (3.54 g, 30 mmol) or 3H(Me)₂PA-methyl ester (3.96 g, 30 mmol) was placed into the reaction flask in the glovebox. Then, the flask was sealed and moved out of glovebox and heated in an oil bath at 160° C. with constant stirring. After observing complete melting of the monomer, catalyst B(C₆F₅)₃ or Ti(OⁿBu)₄ (1 mol % or 0.1 mol %) in o-xylene (1 mL) was added into the flask under the continuous flow of nitrogen gas. The polymerization was stirred under 160° C. for 16 h, then the temperature was increased to 190° C. and stirred for another 16 h at nitrogen atmosphere to make sure the complete conversion of the monomer to oligomers. Subsequently, a vacuum of 200 mTorr was applied to the polycondensation set-up and the reaction mixture was stirred at 190° C. for another 8 h. Finally, the temperature was gradually increased to 240° C. and reacted for another 3 h. After completion of the polymerization, the reaction mixture was cooled down to room temperature under a nitrogen atmosphere. The polymer was purified by dissolving in HFIP, precipitated in methanol for 2-3 times, and dried in vacuo at 60° C. to a constant weight to yield an off-white polymer.

Chemical recycling to lactone monomers (Me)₂PL. To a 5.5 mL glass reactor with a stir bar was added NaOH (5.0 mg, 5 wt %) and P3H(Me)₂P (0.10 g, 1 mmol) obtained by polycondensation of 3H(Me)₂PA-methyl ester. The mixture was heated at 230° C. (oil bath) and distilled under vacuum with a receiving flask cooled under liquid nitrogen. After the powder disappeared, the vacuum was turned off, and the cold bath was removed. As the flask was warmed to room temperature, a colorless liquid was received, which was confirmed to be the recycled, pure monomer (Me)₂PL (76% isolated yield) by ¹H NMR analysis.

Chemical recycling to HA monomers 3H(Me)₂PA. A solution of P3H(Me)₂P (100 mg) and aqueous NaOH (320 mg, 4 mL H₂O) in THF/MeOH (4/0.5 mL) was reacted at 80° C. for 24 h in a Schlenk flask. Aqueous HCl (2 N) was added to adjust the PH value to 1, followed by extraction with EtOAc (15 mL×3). The organic phase was washed with brine, dried over Na₂SO₄, and then evaporated in vacuo to give the recycled, pure 3H(Me)₂PA in 99% isolated yield.

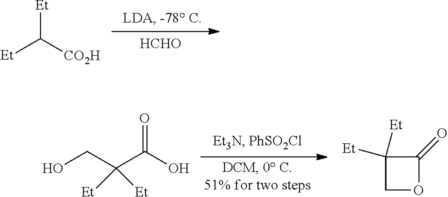 [SMILES: CCC(CC)C(=O)O ; "HCHO" ; CCC(CC)(CO)C(=O)O ; CCC1(CC)COC1=O]

Synthesis of α,α-diethyl-f-propiolactone [(Et)₂PL]: To a solution of diisopropylamine (48 mL, 345 mmol) in THF (250 mL), ⁿBuLi (215 mL, 345 mmol, 1.6 M) was added slowly at 0° C. and the mixture was stirred at this temperature for 1 h. After 15 min at −78° C., 2-ethylbutyric acid (18.9 mL, 150 mmol) in THF (100 mL) was added dropwise. The reaction mixture was stirred at −78° C. for 0.5 h and then at 55° C. for 4 h. Paraformaldehyde (9 g, 300 mmol) was added at −20° C., followed by stirring for 0.5 h. The reaction mixture was then allowed to room temperature about 12 h. After quenching with H₂O, aqueous HCl (4 N) was added to adjust the PH value to 1. The solution was extracted with EtOAc (150 mL×3), and the combined organic phase was washed with brine, dried over Na₂SO₄, and then evaporated in vacuo and simple vacuum distillation (about 200 mTorr, 160-180° C.) to give the crude 3-hydroxy-2,2-diethylpropionic acid [3H(Et)₂PA].

Triethylamine (104 mL, 750 mmol) was added to a stirred solution of 3H(Et)₂PA in dry DCM (900 mL) at 0° C. After 15 min, benzenesulfonyl chloride (38 mL, 300 mmol) was added dropwise, followed by stirring at 0° C. for 16 h. The mixture was quenched with ice water and extracted with DCM (150 mL×3). The combined organic layers were washed with saturated NaHCO₃, brine, dried over Na₂SO₄, and then evaporated in vacuo. After flash column chromatography on silica gel (pentane/acetone=30/1) and concentration in vacuo, the resultant residue was purified by vacuum distillation (˜200 mTorr, 70-80° C.), affording the monomer (Et)₂PL (9.8 g, 51% for two steps) as a colorless oil. ¹H NMR (400 MHz, CDCl₃): δ 4.10 (s, 2H), 1.84-1.69 (m, 4H), 1.02 (t, J=7.6 Hz, 6H); ¹³C NMR (101 MHz, CDCl₃): δ 174.3, 68.1, 62.6, 25.0, 8.6.

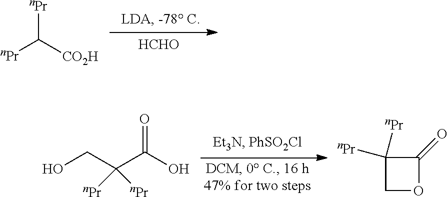

Synthesis of α,α-di-(n-propyl)-β-propiolactone [(ⁿPr)₂PL]: To a solution of diisopropylamine (34 mL, 242 mmol) in THF (200 mL) at 0° C., ⁿBuLi (151 mL, 242 mmol, 1.6 M) was added dropwise. After 1 h under stirring, the reaction mixture was cooled to −78° C., and 2-propylpentanoic acid (16.8 mL, 105 mmol) in THF (80 mL) was added dropwise. After 0.5 h, the solution was heated at 55° C. for 4 h, followed by the addition of paraformaldehyde (6.3 g, 210 mmol) at −20° C., stirring for 0.5 h and heating at 0° C. for 2 h. Then the mixture was quenched with H₂O and HCl aqueous (4 N) was added to adjust the PH value to 1. After extraction with EtOAc (150 mL×3), the organic phase was washed with brine, dried over Na₂SO₄, and evaporated in vacuo to give the crude 3-hydroxy-2,2-di-(n-propyl)-propionic acid [3H(ⁿPr)₂PA], which was directly used in the next step without further purification.

3H(ⁿPr)₂PA was dissolved in dry DCM (600 mL), then triethylamine (71.4 mL, 515 mmol) was added at 0° C. After stirring for 15 min, benzenesulfonyl chloride (26.8 mL, 210 mmol) was added dropwise. The reaction was stirred for 16 h at 0° C., then the mixture was quenched with ice water and extracted with DCM (150 mL×3). The combined organic layers were washed with saturated NaHCO₃, brine, dried over Na₂SO₄, and then evaporated in vacuo. The resultant residue was purified by flash column chromatography on silica gel (pentane/acetone=30/1) and concentrated in vacuo, followed by the addition of chloroform (80 mL) and sodium hydroxide solution (6.7 g NaOH, 4 N). After stirring at 50° C. for 6 h, the mixture was extracted with DCM (60 mL×3). The combined organic layers were washed with brine, dried over Na₂SO₄, and then evaporated in vacuo. The resultant residue was purified by vacuum distillation (˜200 mTorr, 105-115° C.) to give the monomer (ⁿPr)₂PL (7.7 g, 47% for two steps) as a colorless oil. ¹H NMR (400 MHz, CDCl₃): δ 4.10 (s, 2H), 1.72-1.65 (m, 4H), 1.57-1.44 (m, 2H), 1.41-1.30 (m, 2H), 0.96 (t, J=7.2 Hz, 6H); ¹³C NMR (101 MHz, CDCl₃): δ 174.4, 69.1, 61.4, 34.5, 17.6, 14.1.

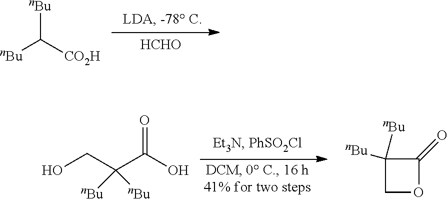

Synthesis of α,α-di-(n-butyl)-β-propiolactone [(ⁿBu)₂PL]: To a solution of diisopropylamine (48 mL, 345 mmol) in THF (250 mL), ⁿBuLi (215 mL, 345 mmol, 1.6 M) was added dropwise at 0° C. After stirring for 1 h, the reaction mixture was cooled at −78° C., and 2-butylhexanoic acid (25.8 mL, 150 mmol) in THF (100 mL) was added dropwise. After 0.5 h, the solution was heated at 55° C. for 4 h, followed by the addition of paraformaldehyde (9 g, 300 mmol) at −20° C., stirring for 0.5 h, and 0° C. for 2 h. Then the mixture was quenched with H₂O and HCl aqueous (4 N) was added to adjust the PH value to 1. After extraction with EtOAc (150 mL×3), the organic phase was washed with brine, dried over Na₂SO₄, and then evaporated in vacuo to give the crude 3-hydroxy-2,2-di-(n-butyl)-propionic acid [3H(ⁿBu)₂PA], which was directly used in the next step without further purification.

3H(ⁿBu)₂PA was dissolved in dry DCM (900 mL), and then triethylamine (104 mL, 750 mmol) was added at 0′° C. After being stirred for 15 min, benzenesulfonyl chloride (38 mL, 300 mmol) was added dropwise. The reaction was stirred for 16 h at 0° C., then the mixture was quenched with ice water and extracted with DCM (150 mL×3). The combined organic layers were washed with saturated NaHCO₃, brine, dried over Na₂SO₄, and then evaporated in vacuo. The resultant residue was purified by flash column chromatography on silica gel (pentane/acetone=30/1) and concentrated in vacuo, followed by the addition of chloroform (80 mL) and sodium hydroxide solution (6.7 g NaOH, 4 N). After stirring at 50° C. for 12 h, the mixture was extracted with DCM (60 mL×3). The combined organic layers were washed with brine, dried over Na₂SO₄, and then evaporated in vacuo. The resultant residue was purified by vacuum distillation (˜200 mTorr, 125-135° C.) to give the monomer (ⁿBu)₂PL (11.3 g, 41% for two steps) as a colorless oil. ¹H NMR (400 MHz, CDCl₃): δ 4.08 (s, 2H), 1.73-1.65 (m, 4H), 1.47-1.22 (m, 8H), 0.91 (t, J=7.2 Hz, 6H); ¹³C NMR (101 MHz, CDCl₃): δ 174.6, 69.1, 61.4, 32.2, 26.4, 22.8, 13.8.

TABLE 8
Results of ROP of (R)₂PL, R = Me, Et, ⁿPr, ⁿBu.

| | | | [M]/ | Solvent, | Temp. | Mₙ ^{c} | Ð ^{c} |
|---|---|---|---|---|---|---|---|
| Run ^{a} | Monomer | Catalyst | [Cat.]/[I] | (mol/L) | (° C.) | (kDa) | (M_{w}/Mₙ) |
| 1 | (Me)₂PL | TBD | 400/1/1 | neat | 70 | 17.6 | 1.17 |
| 2 | (Me)₂PL | TBD | 800/1/1 | neat | 70 | 27.3 | 1.25 |
| 3 | (Me)₂PL | TBD | 1600/1/1 | neat | 70 | 34.0 | 1.33 |
| 4 | (Me)₂PL | TBD | 3200/1/1 | neat | 70 | 42.1 | 1.54 |
| 5 | (Me)₂PL | DBU | 400/1/1 | neat | 70 | 23.0 | 1.27 |
| 6 | (Me)₂PL | DBU | 800/1/1 | neat | 70 | 31.6 | 1.41 |
| 7 ^{b1} | (Me)₂PL | DBU | 1600/1/1 | neat | 70 | 47.8 | 1.55 |
| 8 ^{b2} | (Me)₂PL | DBU | 3200/1/1 | neat | 70 | 65.5 | 1.67 |
| 9 | (Me)₂PL | ^{t}Bu—P₄ | 400/1/1 | neat | 70 | 20.7 | 1.11 |
| 10 | (Me)₂PL | ^{t}Bu—P₄ | 800/1/1 | neat | 70 | 34.3 | 1.37 |
| 11 ^{b3} | (Me)₂PL | ^{t}Bu—P₄ | 1600/1/1 | neat | 70 | 58.7 | 1.48 |
| 12 | (Me)₂PL | ^{t}Bu—P₄ | 3200/1/1 | neat | 70 | 75.9 | 1.54 |
| 13 ^{b4} | (Me)₂PL | ^{t}Bu—P₄ | 6400/1/1 | neat | 70 | 162 | 1.43 |
| 14 | (Me)₂PL | ^{t}Bu—P₄ | 1600/1/1 | neat | 240 | 44.0 | 1.58 |
| 15 | (Me)₂PL | ^{t}Bu—P₄ | 1600/1/1 | DiFB, 2M | 70 | 27.4 | 1.46 |
| 16 | (Et)₂PL | ^{t}Bu—P₄ | 3200/1/1 | neat | 70 | 79.7 | 1.25 |
| 17 ^{b5, d} | (Me)₂/(Et)₂PL (50/50) | ^{t}Bu—P₄ | 1600/1600/1/1 | neat | 70 | 78.5 | 1.05 |
| 18 ^{e} | (ⁿPr)₂PL | ^{t}Bu—P₄ | 1600/1/1 | neat | 70 | — | — |
| 19 ^{e} | (ⁿBu)₂PL | ^{t}Bu—P₄ | 1600/1/1 | neat | 70 | — | — |

^{a} Conditions: monomer (M) (1 mmol), initiator (I) = BnOH, 1 h.
^{b} Conversion determined by ¹H NMR in d-HFIP, b1: 90.3%, b2: 58.3%, b3: 100%, b4: 100%, b5: 100%/100%.
^{c} Number-average molecular weight (Mₙ) and dispersity index (Ð = M_{w}/Mₙ) determined by gel-permeation chromatography (GPC) at 40° C. in HFIP coupled with a Wyatt Technology miniDAWN TREOS multi-angle light scattering detector and a Wyatt Technology Optilab T-rEX differential refractometer for absolute molecular weights.
^{d} (Me)₂PL (8.13 mmol), (Et)₂PL (8.13 mmol).
^{e} Polymer was not soluble, even in HFIP.

TABLE 9
Results of polycondensation of 3H(Me)₂PA and 3H(Me)₂PA-methyl ester.

| | | | [M]/ | Yield | Mₙ ^{c} | M_{w} ^{c} | Ð ^{c} |
|---|---|---|---|---|---|---|---|
| Run ^{a} | Monomer | Cat. | [Cat.] | (%) ^{b} | (kDa) | (kDa) | (M_{w}/Mₙ) |
| 1 | 3H(Me)₂PA | Ti(OⁿBu)₄ | 100/1 | 92 | 11.7 | 26.4 | 2.25 |
| 2 | 3H(Me)₂PA | B(C₆F₅)₃ | 100/1 | 87 | 20.9 | 29.1 | 1.39 |
| 3 | 3H(Me)₂PA | Ti(OⁿBu)₄ | 1000/1 | 63 | 22.8 | 35.2 | 1.50 |
| 4 | 3H(Me)₂PA-ester | Ti(OⁿBu)₄ | 100/1 | 95 | 7.9 | 14.3 | 1.81 |

^{a} Conditions: monomer (30 mmol).
^{b} Precipitated in methanol, dried in vacuo, and then weighted.
^{c} Number-average molecular weight (Mₙ) and dispersity index (Ð = M_{w}/Mₙ) determined by gel-permeation chromatography (GPC) at 40° C. in HFIP coupled with a Wyatt Technology miniDAWN TREOS multi-angle light scattering detector and a Wyatt Technology Optilab T-rEX differential refractometer for absolute molecular weights.

TABLE 10
Results of hydrolytic depolymerization of P3H(Me)₂P.

| | | | Isolated |
|---|---|---|---|
| | | | monomer |
| Run ^{a} | Monomer, Method for P3H(Me)₂P | Condition | yield (%) |
| 1 | (Me)₂PL, ROP, | NaOH (4N, 2 mL), THF/MeOH (30/0.5 | 95 |
| | Mₙ = 20.7 kDa, Ð = 1.11 | mL), 80° C., 24 h | |
| 2 | (Me)₂PL, ROP | NaOH (4N, 8 mL), THF/MeOH (30/0.5 | 88 |
| | Mₙ = 20.7 kDa, Ð = 1.11 | mL), 80° C., 24 h | |
| 3 | (Me)₂PL, ROP | NaOH (4N, 4 mL), THF/MeOH (4/0.5 | 99 |
| | Mₙ = 20.7 kDa, Ð = 1.11 | mL), 80° C., 24 h | |
| 4 | (Me)₂PL, ROP | LiOH (4N, 4 mL), THF/MeOH (4/0.5 | 92 |
| | Mₙ = 20.7 kDa, Ð = 1.11 | mL), 80° C., 72 h | |
| 5 | (Me)₂PA, PCR | NaOH (4N, 4 mL), THF/MeOH (4/0.5 | 99 |
| | Mₙ = 22.8 kDa, Ð = 1.50 | mL), 80° C., 24 h | |
| 6 | (Me)2PA-methyl ester, PCR | NaOH (4N, 4 mL), THF/MeOH (4/0.5 | 99 |
| | Mₙ = 7.9 kDa, Ð = 1.81 | mL), 80° C., 24 h | |

^{a} Conditions: P3H(Me)₂P (100 mg).
Note:
The temperature should not be above 100° C. to prevent solid from being blown to the upper bottle wall.

TABLE 11
Tensile data for P3H(Me/Et)₂P produced by
a [(Me)₂PL]/[(Et)₂PL]/[^{t}Bu—P₄]/[BnOH]
ratio of 1600/1600/1/1.

| | Stress | Strain | Modulus | Toughness |
|---|---|---|---|---|
| Entry | (MPa) | (%) | (GPa) | (MJ m⁻³) |
| 1 | 39.6 | 331 | 0.75 | 89 |
| 2 | 39.0 | 344 | 0.72 | 89 |
| 3 | 35.9 | 329 | 0.69 | 84 |
| Average | 38.2 | 335 | 0.72 | 87 |
| Standard | 2.0 | 8 | 0.03 | 3 |
| deviation | | | | |

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

1. A polymer comprising Formula I: 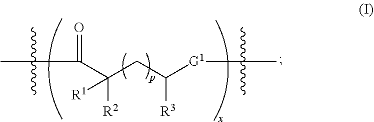
wherein
G¹ is O, S, or NR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl;
p is 0 to 5; and x is 10 to about 500,000.

2. The polymer of claim 1 wherein R¹ and R² are methyl, ethyl, propyl, or butyl, and R³ is hydrogen, methyl, ethyl, propyl, or butyl.

3. The polymer of claim 1 wherein p is 0 or 2.

4. The polymer of claim 1 wherein x is about 20 to about 500,000.

5. A polymer of claim 1 wherein the polymer is a copolymer comprising Formula II: 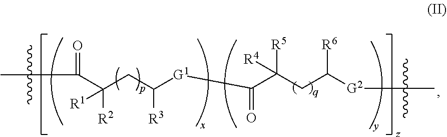
wherein
G¹ and G² are each independently O, S, or NR wherein R^{b} is H or —(C₁-C₁₂)alkyl;
R⁴ and R⁵ are each independently —(C₁-C₁₂)alkyl, —(C₂-C₁₂)alkenyl, —(C₂-C₁₂)alkynyl, aryl or heteroaryl; or
R⁴ and R⁵ taken together with the carbon atom to which they are attached form a (C₃-C₁₆)cycloalkyl;
R⁶ is H, —(C₁-C₁₂)alkyl, —(C₂-C₁₂)alkenyl, —(C₂-C₁₂)alkynyl, aryl or heteroaryl;
q is 0 to 5;
y is 10 to about 500,000; and z is 1 to about 100,000;
wherein the structure of the repeating units represented by x and y of Formula II are different.

6. The copolymer of claim 5 wherein R⁴ and R⁵ are methyl, ethyl, propyl, or butyl, and R⁶ is hydrogen, methyl, ethyl, propyl, or butyl.

7. The copolymer of claim 5 wherein y is about 20 to about 500,000 and z is about 10 to about 100,000.

8. A method for forming a polymer of claim 1, comprising ring opening polymerization (ROP) of a monomer of Formula III: 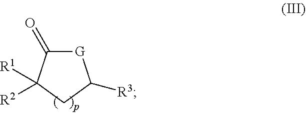
wherein
G¹ is O, S, or NR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl; and
p is 0 to 5;
wherein ROP comprises contacting the monomer of Formula III, a catalyst, and an initiator;
wherein the polymer is thereby formed.

9. The method of claim 8 wherein the catalyst is {1-tert-butyl-4,4,4-tris(dimethylamino)-2,2-bis[tris(dimethylamino)phosphoranyliden-amino]2λ⁵,4λ⁵-catenadi(phosphazene)}(^{t}Bu-P₄), and the initiator is aliphatic alcohol or aryl alcohol.

10. A method for forming a polymer of claim 1, comprising step-growth polycondensation (SGP) of a monomer of Formula IV: 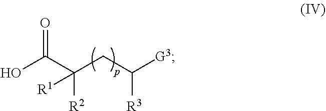
wherein
G³ is OH, SH, or NHR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl; and p is 0 to 5;
wherein SGP comprises contacting the monomer of Formula IV and a catalyst;
wherein the polymer is thereby formed.

11. The method of claim 10 wherein the catalyst is a Lewis acid.

12. The method of claim 10 wherein the monomer is optically active.

13. A method for depolymerizing a polymer of claim 1, comprising contacting the polymer and a base, wherein the polymer is depolymerized to its constituent monomer and conversion to the constituent monomer is about 20 wt. % or more.

14. The method of claim 13 wherein the constituent monomer is represented by Formula III: 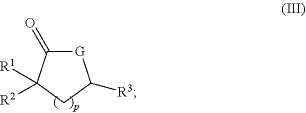
wherein
G¹ is O, S, or NR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl; and p is 0 to 5

15. The method of claim 13 wherein the constituent monomer is represented by Formula IV: 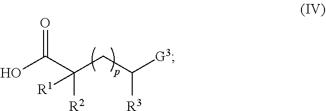
wherein
G³ is OH, SH, or NHR^{a} wherein R^{a} is H or —(C₁-C₁₂)alkyl;
R¹ and R² are each independently —(C₁-C₁₂)alkyl, —(C₂-C₁₂)alkenyl, —(C₂-C₁₂)alkynyl, aryl or heteroaryl; or
R¹ and R² taken together with the carbon atom to which they are attached form a (C₃-C₁₆)cycloalkyl;
R³ is H, —(C₁-C₁₂)alkyl, —(C₂-C₁₂)alkenyl, —(C₂-C₁₂)alkynyl, aryl or heteroaryl; and
p is 0 to 5.

16. The method of claim 8 wherein the monomer is optically active.
